(19) United States
(12) Patent Application Publication
(10) Pub. No.: US 2022/0177278 A1
(43) Pub. Date: Jun. 9, 2022

(54) HOLDING APPARATUS AND WORK MACHINE INCLUDING THE SAME

(71) Applicant: KOBELCO CONSTRUCTION MACHINERY CO., LTD., Hiroshima-shi (JP)

(72) Inventors: Yasuhiko SHIMAZU, Hiroshima (JP); Ryunosuke MIYAZAKI, Hiroshima (JP); Nobuhiro FUKUO, Hiroshima (JP); Koji YAMASHITA, Hiroshima (JP)

(73) Assignee: KOBELCO CONSTRUCTION MACHINERY CO., LTD., Hiroshima-shi (JP)

(21) Appl. No.: 17/456,061

(22) Filed: Nov. 22, 2021

(30) Foreign Application Priority Data
Dec. 9, 2020 (JP) 2020-204194
Jul. 21, 2021 (JP) 2021-120200

(51) Int. Cl. B66C 1/68; B66C 1/42

(52) U.S. Cl. CPC B66C 1/68; B66F 9/18; B66C 1/42

(57) ABSTRACT

Provided is a holding apparatus capable of holding a holding object with sufficient holding force from either of the outside and the inside. The holding apparatus includes a holding-apparatus body, a first and second arms, an opening and closing mechanism, a driving device, and a first and second holding elements. The opening and closing mechanism interconnects each of the first and second arms and the holding apparatus main bodies so as to allow the first and second arms to be moved in the opening and closing direction while kept in the holding posture. The first and second holding elements is pivotably connected to the arm lower region, having respective inner contact surfaces opposed to each other in the opening and closing direction and respective outer contact surfaces facing the opposite side.

### TECHNICAL FIELD

The present invention relates to a holding apparatus provided on a work machine to hold a holding object and relates to a work machine including the holding apparatus.

### BACKGROUND ART

Patent Document 1 (Japanese Unexamined Patent Publication No. 2003-192265) discloses a device for gripping waste household electric appliance, the device attached to an arm of a hydraulic excavator. The device has a pair of claws, which have respective straight shapes and make open and close action while being kept parallel to each other.

Patent Document 2 (Japanese Unexamined Patent Publication No. Sho 61-94991) discloses a gripping device attached to an arm of a hydraulic excavator. The gripping device includes a pair of claws, which grip an object from the outside thereof. Each of the pair of claws has a vertical gripping surface.

Patent Document 3 (Japanese Unexamined Utility Model Publication No. 59-116459) discloses a multipurpose bucket attached to an arm of a hydraulic excavator. The multipurpose bucket includes a pair of gripping arms extending from a bucket body, and respective receiving members attached to the pair of gripping arms. Patent Document 3 discloses that the receiving member can be used as both an inner receiving member for holding the groove-like body from the inside and an outward receiving member for holding the groove-like body from the outside.

Each of devices described in Patent Document 1 and Patent Document 2, however, is configured to grip an object from the outside of an object, being incapable of holding any object from the inside thereof. On the other hand, the use of the receiving member described in Patent Document 3 for both holding from the outside and holding from the inside requires great change in the posture of the receiving member, which takes time and labor. Besides, both the holding from the outside and the holding from the inside are desired to be performed flexibly in correspondence with the shape of the holding object.

### SUMMARY OF INVENTION

It is an object of the present invention to provide a holding apparatus that is provided on a work machine and capable of both holding a holding object from the outside thereof and holding a holding object from the inside thereof with sufficient holding force flexibly in correspondence with the shape of the holding object, and to provide a work machine including the holding apparatus.

Provided is a holding apparatus, which is capable of holding a holding object while being connected to a distal end of an attachment body of a work machine comprising the attachment body that has the distal end and is operable to move the distal end, the holding apparatus and the attachment body constituting a work attachment. The holding apparatus includes a holding-apparatus body, a first arm, a second arm, an opening and closing mechanism, a driving device, a first holding element, and a second holding element. The holding-apparatus body is connectable to the distal end of the attachment body. The first arm and the second arm are aligned in an opening and closing direction. Each of the first arm and the second arm includes an arm upper region connected to the holding-apparatus body and an arm lower region extending downward from the arm upper region in a holding posture. The opening and closing mechanism is interposed between the holding-apparatus body and the arm upper region of each of the first arm and the second arm. The opening and closing mechanism connects the arm upper region of each of the first arm and the second arm to the holding-apparatus body so as to allow each of the first arm and the second arm to be translated in the opening and closing direction while keeping the first arm and the second arm in the holding posture to the holding-apparatus body. The holding posture is a posture where the arm lower region extends downward from the arm upper region. The driving device actuates the opening and closing mechanism to change an arm interval. The arm interval is an interval between the first arm and the second arm in the opening and closing direction. The first holding element is connected to the arm lower region of the first arm pivotably around a first holding pivot axis extending in a front-rear direction perpendicular to each of a vertical direction of the holding apparatus and the opening and closing direction. The second holding element is connected to the arm lower region of the second arm pivotably around a second holding pivot axis extending in the front-rear direction. The first holding element and the second holding element have respective inner contact surfaces opposed to each other in the opening and closing direction and respective outer contact surfaces facing opposite sides to the inner contact surfaces, respectively, with respect to the opening and closing direction.

### BRIEF DESCRIPTION OF DRAWINGS

FIG. 1 is a side view of a work machine according to a first embodiment of the present invention.

FIG. 2 is a front view of a holding apparatus according to the first embodiment, in which the arm interval is small.

FIG. 3 is a side view of the holding apparatus.

FIG. 4 is a front view of the holding apparatus, in which the arm interval is large.

FIG. 5 is a perspective view showing an arm lower region of each of first and second arms in the holding apparatus and each of first and second holding elements connected to the arm lower region.

FIG. 6 is a perspective view of each of the first and second holding elements.

FIG. 7 is a front view of a holding apparatus according to a first modification, in which the arm interval is small.

FIG. 8 is a front view of the holding apparatus according to the first modification, in which the arm interval is large.

FIG. 9 is a perspective view showing an arm lower region of the holding apparatus according to a second modification and a holding element connected to the arm lower region.

FIG. 10 is a perspective view showing an arm lower region of the holding apparatus according to the second embodiment of the present invention, and first and second holding elements connected to the arm lower region.

FIG. 11 is a perspective view showing an arm lower region according to a first modification of the second embodiment, and first and second holding elements connected to the arm lower region.

FIG. 12 is a perspective view showing an arm lower region according to a second modification of the second embodiment and each of first and second holding elements connected to the arm lower region.

FIG. 13 is a perspective view of an arm lower region to be compared with the second modification and each of first and second holding elements connected to the arm lower region.

FIG. 14 is a perspective view showing an arm lower region according to another modification and each of first and second holding elements connected to the arm lower region.

### DESCRIPTION OF EMBODIMENTS

Hereinafter, a preferred embodiment of the present invention will be described with reference to the accompanying drawings.

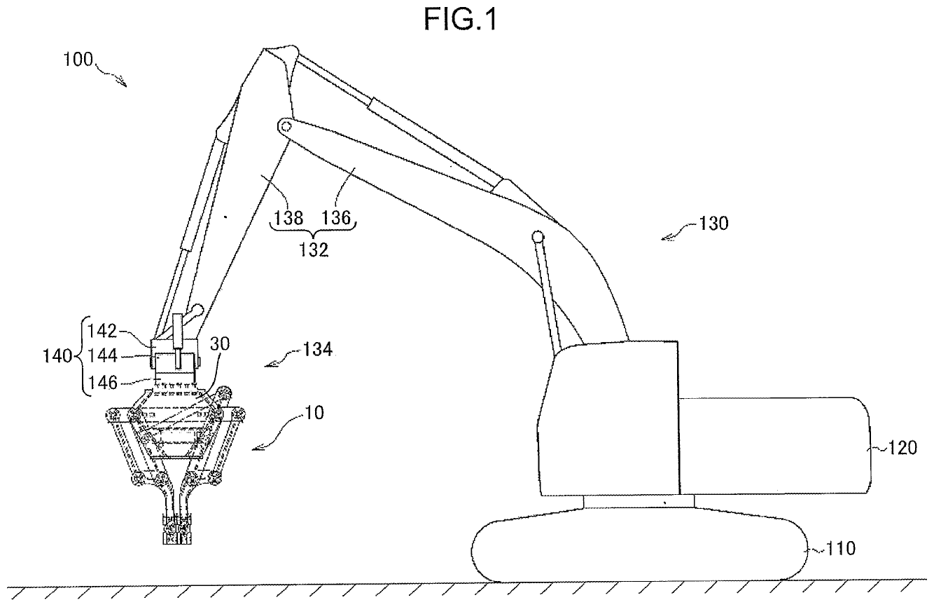

FIG. 1 shows a holding apparatus 10 according to a first embodiment of the present invention and a work machine 100 including the holding apparatus 10. The holding apparatus 10 is provided to the work machine 100 to hold a carrying object which is a holding object. The holding apparatus is especially suitable for a carrying object which is opened upward. The work machine 100 includes a work attachment 130 capable of making a work motion. The work machine 100 illustrated in FIG. 1 is a hydraulic excavator.

The work machine 100 includes a lower traveling body 110, an upper turning body 120, and the work attachment 130.

The lower traveling body 110 is capable of making a traveling motion, including, for example, a pair of crawlers. The upper turning body 120 is mounted on the lower traveling body 110 so as to be turnable.

The work attachment 130 is attached to the upper turning body 120 so as to be movable rotationally vertically. The work attachment 130 includes an attachment body 132 and a tip attachment 134.

The attachment body 132 includes a boom 136 and an arm 138. The boom 136 has a proximal end and a distal end opposite thereto. The proximal end is attached to the upper turning body 120 so as to be movable rotationally vertically. The upper turning body 120 has a machine right-left direction, which is a direction in which the rotational axis of the boom 136 to the upper turning body 120 extends. The arm 138 is attached to the distal end of the boom 136 so as to be movable rotationally vertically. The rotational axis of the arm 138 to the boom 136 extends in the machine right-left direction.

The distal end of the arm 138 is equivalent to the distal end of the attachment body 132. The distal end of the attachment body 132 can be moved relatively to the upper turning body 120 by respective rotational movements of the boom 136 and the arm 138.

The tip attachment 134 is connected to the distal end of the arm 138, i.e., the distal end of the attachment body 132, thus being movable with the distal end. The tip attachment 134 includes a rotation drive mechanism 140 and the holding apparatus 10.

The rotation drive mechanism 140 is interposed between the distal end of the attachment body 132 and the holding apparatus 10 to rotate the holding apparatus 10 relatively to the attachment body 132 around a plurality of axes.

The rotation drive mechanism 140 includes a main body section 142, a tilt section 144, and a turning section 146.

The main body section 142 is fixed to the distal end of the arm 138, thus being configured to be moved integrally with the arm 138.

The tilt section 144 is interposed between the main body section 142 and the pair of the turning section 146 and the holding apparatus 10 to tilt the turning section 146 and the holding apparatus 10 to the main body section 142, specifically, to move the turning section 146 and the holding apparatus 10 rotationally around a tilt axis relatively to the main body section 142. The tilt axis extends in a direction perpendicular to the machine right-left direction. The tilt axis is an axis parallel to a plane including an opening and closing direction and the front-rear direction of the holding apparatus 10 (that is, a horizontal plane in FIG. 1) as described below in detail. The tilt section 144, thus, can serve as a tilt device that tilts the holding apparatus 10 to the attachment body 132.

The turning section 146 is interposed between the tilt section 144 and the holding apparatus 10 to turn the holding apparatus 10 around a turning axis relatively to the tilt section 144. The turning axis extends in a turning axis direction. The turning axis direction is a direction perpendicular to each of the opening and closing direction and the front-rear direction of the holding apparatus 10, namely, a vertical direction in FIG. 1. The turning axis direction is, in other words, a direction parallel to an attachment direction in which the holding apparatus 10 is attached to the distal end of the attachment body 132, i.e., the distal end of the arm 138. The turning section 146 can serve as a turning device that turns the holding apparatus 10 around the turning axis relatively to the attachment body 132.

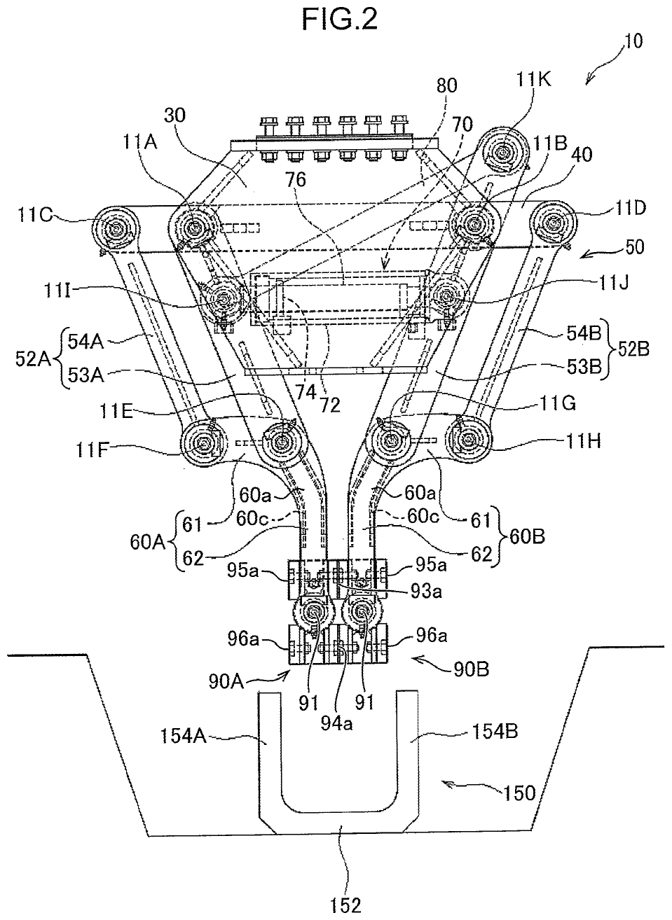

The holding apparatus 10 is capable of holding a holding object while being connected to the attachment body 132 to constitute the work attachment 130. The holding object according to this embodiment is a carrying object 150 shown in FIG. 2. The carrying object 150 has a cross-sectional shape opened upward as described below.

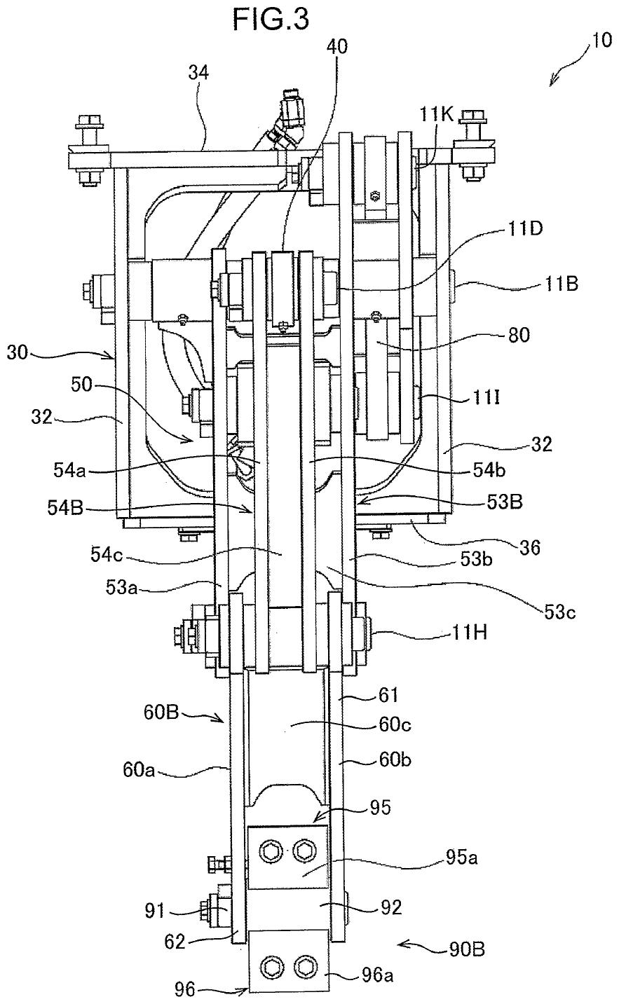

The holding apparatus 10 is attached to the distal end of the attachment body 132. Specifically, the holding apparatus 10 according to this embodiment is connected to the distal end of the arm 138 through the rotation drive mechanism 140. The holding apparatus 10 makes a motion of holding the carrying object 150, specifically, an opening and closing motion in the opening and closing direction. The opening and closing direction is the right-left direction in FIG. 2, being a direction perpendicular to the paper surface in FIG. 3.

As shown in FIGS. 2 and 3, the holding apparatus 10 includes a box body 30, a bar 40, an opening and closing mechanism 50, a first arm 60A, a second arm 60B, a driving device 70, an interlock member 80, a first holding element 90A, and a second holding element 90B.

The box body 30 and the bar 40 constitute a holding-apparatus body. The holding-apparatus body supports the first and second arms 60A and 60B through the opening and closing mechanism 50 while being connected to the attachment body 132.

The box body 30 is attachable to the distal end of the attachment body 132. Specifically, the box body 30 can be connected to the distal end of the arm 138 through the rotation drive mechanism 140, more specifically, can be fixed to the turning section 146 of the rotation drive mechanism 140.

The box body 30 includes a pair of side plates 32, a top plate 34, and a bottom plate 36. The pair of side plates 32 are spaced in the front-rear direction and paralleled to each other. The front-rear direction is a direction perpendicular to each of a vertical direction of the holding apparatus 10 and the opening and closing direction, namely, the right-left direction in FIG. 3, the direction perpendicular to the paper surface in FIG. 2. The vertical direction of the holding apparatus 10 is a direction in which the holding-apparatus body and the first and second arms 60A and 60B are arranged, the opening and closing direction being perpendicular to the vertical direction. The top plate 34 is connected to respective upper ends of the pair of side plates 32 so as to interconnect the upper ends. The bottom plate 36 is connected to respective center parts of the lower end of the pair of side plates 32 so as to interconnect the center parts. The right and left ends of respective lower sides of the pair of side plates 32 are spaced in the front-rear direction to form respective openings, thereby allowing the below-described movement of the opening and closing mechanism 50.

The bar 40 is combined with the box body 30 to constitute the holding-apparatus body in cooperation with the box body 30. The bar 40 has a plate shape extending in a single direction, being fixed to the box body 30 while penetrating the inside of the box body 30 in the right-left direction, i.e., the opening and closing direction. The bar 40 has longitudinally opposite ends, namely, right and left ends, which protrude outward beyond the right and left sides of the box body 30, respectively. The bar 40 is fixed to the right-left direction opposite ends of the box body 30 through respective pins 11A and 11B. As shown in FIG. 3, the pins 11A and 11B penetrate the box body 30 in the front-rear direction (right-left direction in FIG. 3) and are fixed to the pair of side plates 32 of the box body 30. The bar 40, thus, can be attached to the attachment body 132 through the box body 30.

As shown in FIG. 2, the first and second arms 60A and 60B are spaced and aligned in the opening and closing direction, each being kept in a specified holding posture. Each of the first and second arms 60A and 60B has an arm upper region 61 and an arm lower region 62. The arm upper region 61 extends in the opening and closing direction in the holding posture, being connected to the holding-apparatus body, namely, the box body 30 and the bar 40 in this embodiment, through the opening and closing mechanism 50. The arm lower region 62 extends downward from the inner end of the arm upper region 61 in the holding posture. The inner end is an inner end with respect to the opening and closing direction. The inner end of the first arm 60A that is shown on the left side in FIG. 2 is the right end and the inner end of the second arm 60B that is shown on the right side is the left end.

Each of the first and second arms 60A and 60B includes a pair of arm plates 60a and 60b and a reinforcing plate 60c as shown in FIG. 3. The pair of arm plates 60a and 60b serve as support members for supporting the first and second holding elements 90A and 90B, respectively, as will be described later in detail, being paralleled to each other and spaced in the front-rear direction, that is, in the right-left direction in FIG. 3. The reinforcing plate 60c is interposed between the pair of arm plates 60a and 60b to interconnect them in the front-rear direction. FIG. 3 shows only the second arm 60B out of the first and second arms 60A and 60B.

The opening and closing mechanism 50 is interposed between each of the first arm 60A and the second arm 60B and the holding-apparatus body, namely, the box body 30 and the bar 40 in this embodiment. The opening and closing mechanism 50 connects respective arm regions 61 of the first arm 60A and the second arm 60B to the holding-apparatus body so as to allow the first arm 60A and the second arm 60B to be translated relatively to the holding-apparatus body in the opening and closing direction while being kept in the holding posture.

As shown in FIG. 2, the opening and closing mechanism 50 includes a first link pair 52A and a second link pair 52B, which are disposed on the left and right sides, respectively, in FIG. 2. The first link pair 52A constitutes a parallel-link mechanism in cooperation with the arm upper region 61 of the first arm 60A and the holding-apparatus body to keep the first arm 60A in the holding posture. Similarly, the second link pair 52B constitutes a parallel-link mechanism in cooperation with the arm upper region 61 of the second arm 60B and the holding-apparatus body to keep the second arm 60B in the holding posture.

The first link pair 52A includes a pair of first link members, namely, a first inner link member 53A and a first outer link member 54A. The first inner link member 53A and the first outer link member 54A are paralleled to each other.

The first inner link member 53A is disposed on the inner side in the opening and closing direction, i.e., on the side close to the center of the holding-apparatus body with respect to the opening and closing direction, namely, the right side in FIG. 2. The first inner link member 53A has an upper end, which is pivotably connected to the left end of the box body 30 and the bar 40 through the pin 11A. The pin 11A serves as a first body-side pivot, and the first inner link member 53A is allowed to pivot around the center axis of the pin 11A to the holding-apparatus body.

The first outer link member 54A is disposed on the outer side in the opening and closing direction, that is, on the side far from the center of the holding-apparatus body in the opening and closing direction, namely, the left side in FIG. 2. The first outer link member 54A has an upper end, which is pivotably connected to one end of the bar 40, namely, the left end in FIG. 2, through a pin 11C. The pin 11C serves as a first body-side pivot similarly to the pin 11A, and the first outer link member 54A is allowed to pivot around the center axis of the pin 11C to the holding-apparatus body.

The second link pair 52B includes a pair of second link members, namely, a second inner link member 53B and a second outer link member 54B. The second inner link member 53B and the second outer link member 54B are paralleled to each other.

The second inner link member 53B is disposed on the inner side in the opening and closing direction, i.e., on the side close to the center of the holding-apparatus body with respect to the opening and closing direction, namely, the left side in FIG. 2. The second inner link member 53B has an upper part, a slightly lower part than the upper end in this embodiment, which is pivotably connected to the right end of the box body 30 and the bar 40 through the pin 11B similar to the pin 11A. The pin 11B serves as a second body-side pivot, and the second inner link member 53B is allowed to pivot around the center axis of the pin 11B to the holding-apparatus body.

The second outer link member 54B is disposed on the outer side in the opening and closing direction, that is, on the side far from the center of the holding-apparatus body with respect to the opening and closing direction, namely, the right side in FIG. 2. The second outer link member 54B has an upper end, which is connected to the other end of the bar 40, namely, the right end in FIG. 2, through a pin 11D. The pin 11D serves as a second body-side pivot similarly to the pin 11B, and the second outer link member 54B is allowed to pivot around the center axis of the pin 11D to the holding-apparatus body.

Each of the first and second inner link members 53A and 53B includes a pair of link plates 53a and 53b and an interconnection member 53c as shown in FIG. 3. The pair of link plates 53a and 53b are spaced in the front-rear direction (right-left direction in FIG. 3) and paralleled to each other. The interconnection member 53c is interposed between the pair of link plates 53a and 53b to interconnect them. FIG. 3 shows only the second inner link member 53B out of the first and second inner link members 53A and 53B.

Similarly, each of the first and second outer link members 54A and 54B includes a pair of link plates 54a and 54b and an interconnection member 54c as shown in FIG. 3. The pair of link plates 54a and 54b are spaced in the front-rear direction (right-left direction in FIG. 3) and paralleled to each other. The interconnection member 54c is interposed between the pair of link plates 54a and 54b to interconnect them. FIG. 3 shows only the second outer link member 54B out of the first and second outer link members 54A and 54B.

The first inner and outer link members 53A and 54A have respective lower ends, which are pivotably connected to the arm upper region 61 of the first arm 60A through respective pins 11E and 11F. Specifically, the pins 11E and 11F are fixed to the arm upper region 61 of the first arm 60A, and the lower ends of the first inner and outer linking members 53A and 54A are connected to the pins 11E and 11F, respectively. The pin 11E penetrates the inner part of the arm upper region 61 with respect to the opening and closing direction, namely, the right part in FIG. 2, in the front-rear direction, and the pin 11F penetrates the outer part of the arm upper region 61 with respect to the opening and closing direction, namely, the left part in FIG. 2, in the front-rear direction. The first inner and outer link members 53A and 54A are allowed to pivot around respective center axes of the pins 11E and 11F, that is, around respective first arm-side pivots, relatively to the first arm 60A.

The second inner and outer link members 53B and 54B have respective lower ends, which are pivotably connected to the arm upper region 61 of the second arm 60B through respective pins 11G and 11H. Specifically, the pins 11G and 11H are fixed to the arm upper region 61 of the second arm 60B, and respective lower ends of the second inner and outer linking members 53B and 54B are connected to the pins 11G and 11H, respectively. The pin 11G penetrates the inner part of the arm upper region 61 with respect to the opening and closing direction, namely, the left part in FIG. 2, in the front-rear direction, and the pin 11F penetrates the outer part of the arm upper region 61 with respect to the opening and closing direction, namely, the right part in FIG. 2, in the front-rear direction. The second inner and outer link members 53B and 54B are allowed to pivot around respective center axes of the pins 11G and 11H, that is, around respective second arm-side pivots, relatively to the second arm 60B.

The interval between the pins 11E and 11F, each of which is the first arm-side pivot, is equal to the interval between the pins 11A and 11C, each of which is the first body-side pivot. The pins 11A, 11C, 11E and 11F, therefore, are kept be respective apexes of a parallelogram regardless of the rotational movements of the first inner and outer link members 53A and 54A, thereby enabling the first arm 60A to be translated in the opening and closing direction relatively to the holding-apparatus body while kept in the holding posture.

Similarly, the interval between the pins 11G and 11H, each of which is the second arm-side pivot, is equal to the interval between the pins 11B and 11D, each of which is the second body-side pivot. The pins 11B, 11D, 11G and 11H are, therefore, kept be respective apexes of a parallelogram regardless of the rotational movements of the second inner and outer link members 53B and 54B, thereby enabling the second arm 60B to be translated in the opening and closing direction relatively to the holding-apparatus body while being kept in the holding posture.

In this embodiment, as shown in FIG. 3, respective upper ends of the pair of arm plates 60a and 60b that constitute the first and second arms 60A and 60B are connected to both front and rear ends of the pins 11E, 11F, 11G and 11H, respectively. Respective lower ends of the pair of link plates 53a and 53b that constitute the first and second inner link members 53A and 53B are connected to the pins 11E and 11G, respectively, at respective positions on the opposite outer sides of the pair of arm plates 60a and 60b with respect to the front-rear direction, and respective lower ends of the link plates 54a and 54b that constitute the first and second outer link members 54A and 54B are connected to the pins 11F and 11H, respectively, at respective positions on opposite inner sides of the pair of arm plates 60a and 60b.

The driving device 70 actuates the opening and closing mechanism 50 to change an arm interval. The arm interval is an interval between the first arm 60A and the second arm 60B in the opening and closing direction.

The driving device 70 according to this embodiment is composed of a hydraulic cylinder capable of making expansion and contraction motions. The driving device 70 is disposed between the first and second link pairs 52A and 52B so as to cause the first link pair 51 and the second link pair 52 to be rotationally moved in opposite directions along with the expansion and contraction motions.

The hydraulic cylinder constituting the driving device 70 includes a tube 72, a piston 74 and a rod 76. The tube 72 is formed in a cylindrical shape around a center axis and defines a cylinder chamber inside the tube 72. The center axis extends in a cylinder expansion and contraction direction. The piston 74 is housed in the cylinder chamber so as to be capable of reciprocating in the cylinder expansion and contraction direction. The rod 76 extends in the cylinder expansion and contraction direction and is integrally joined to the piston 74 so as to be moved in the cylinder expansion and contraction direction together with the piston 74 and relatively to the tube 72. The relative movement of the rod 76 to the tube 72 in the cylinder expansion and contraction direction expands and contracts the entire hydraulic cylinder in the cylinder expansion and contraction direction.

The driving device 70 has opposite ends in the cylinder expansion and contraction direction. One of the opposite ends is a rod-side end formed of the distal end of the rod 76, and the other of the opposite ends is a bottom-side end formed of an opposite end of the tube 72 to the rod-side end.

The rod-side end is connected to the first inner link member 53A through a pin 11I. The pin 11I is a first operation point at which the driving force of the driving device 70 is applied to the first link pair 52A. The pin 11I penetrates the first inner link member 53A at the position slightly lower than the upper end of the first inner link member 53A, that is, the position closer to the pin 11E, which is the first arm-side pivot, than the pin 11A, which is the first body-side pivot. The rod-side end is connected to the pin 11I rotatably around the center axis of the pin 11I, thereby being connected to the first inner link member 53A pivotably around the center axis of the pin 11I relatively to the first inner link member 53A.

The bottom end is connected to the second inner link member 53B through a pin 11J. The pin 11J is a second operation point at which the driving force of the driving device 70 is applied to the second link pair 52B. The pin 11J penetrates the second inner link member 53B at a position slightly below the pin 11B, which is the body-side pivot in this embodiment, that is, a position closer to the pin 11G, which is the second arm-side pivot. The rod-side end is connected to the pin 11J rotatably around the center axis of the pin 11J, thereby being connected to the second inner link member 53B pivotably around the center axis of the pin 11J relatively to the second inner link member 53B.

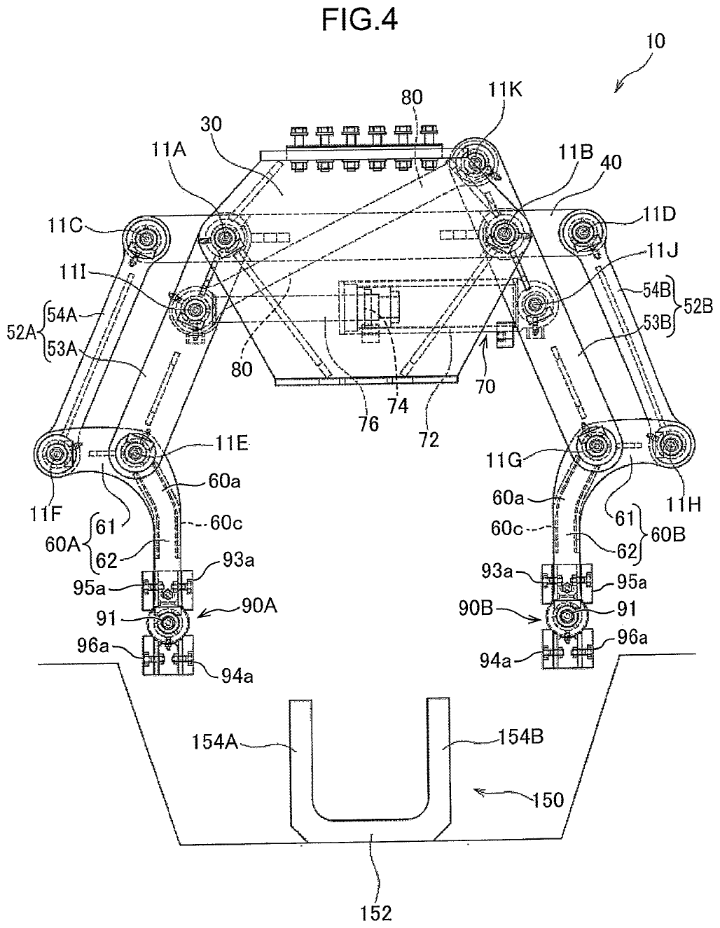

The above disposition of the driving device 70 enables the arm interval, which is the interval between the first and second arms 60A and 60B in the opening and closing direction, to be changed by the expansion and contraction motions of the hydraulic cylinder constituting the driving device 70. Specifically, the contraction of the hydraulic cylinder constituting the driving device 70 as shown in FIG. 2 to decrease the interval between the pins 11I and 11J at opposite ends of the hydraulic cylinder rotationally moves the first and second inner link members 53A and 53B relatively to the holding-apparatus body so as to decrease the interval between the first and second inner link members 53A and 53B that are connected to the pins 11I and 11J, thereby decreasing the arm interval, i.e., making the first and second arms 60A and 60B come closer to each other in the opening and closing direction. In contrast, the expansion of the hydraulic cylinder as shown in FIG. 4 to increase the interval between the pins 11I and 11J rotationally moves the first and second inner link members 53A and 53B relatively to the holding-apparatus body so as to increase the interval between the first and second inner link members 53A and 53B, thereby increasing the arm interval, that is, making the first and second arms 60A and 60B go away from each other in the opening and closing direction.

The driving device 70 is not limited to having opposite ends both of which are connected to the opening and closing mechanism 50. For example, it is also possible that one end of opposite ends of the driving device 70 is pivotally connected to the first inner link member 53A or the first outer link member 53B through the pin 11I or the pin 11J whereas the other end is pivotally connected to the holding-apparatus body, for example, the box body 30 or the bar 40. Besides, the driving device 70 is not limited to a hydraulic actuator but also allowed to be, for example, an expandable and contractable electric cylinder.

As already described, each of the first and second link pairs 52A and 52B, constituting a parallel link mechanism in cooperation with the arm upper region 61 of each of the first and second arms 60A and 60B and the holding-apparatus body, enables the first and second arms 60A and 60B to be kept in their respective holding postures, in which the arm lower region 62 extends downward from the arm upper region 61, regardless of the change in the arm interval. Specifically, the interval between the first arm-side pivots, which are respective axes around which the lower ends of the first inner and outer link members 53A and 54A pivot relatively to the first arm 60A, namely, the pins 11E and 11F in this embodiment, is equal to the interval between the first body-side pivots, which are respective axes around which the upper ends of the first inner and outer link members 53A and 54A, namely, the pins 11A and 11C in this embodiment; similarly, the interval between the second arm-side pivots, which are respective axes around which the lower ends of the second inner and outer link members 53B and 54B, namely, the pins 11G and 11H in this embodiment, pivot relatively to the second arm 60B is equal to the interval between the second body-side pivots, which are respective axes around which the upper ends of the second inner and outer link members 53B and 54B, namely, the pin 11B and 11D in this embodiment, pivot. This enables the first and second arms 60A and 60B to be kept in their respective holding postures, in which the arm lower region 62 extends downward from the arm upper region 61, to the holding-apparatus body regardless of any rotational movement of each of the first and second link pairs 52A and 52B relative to the holding-apparatus body.

The interlock member 80 interconnects the first and second link pairs 52A and 52B to interlock the first link pair 52A and the second link pair 52B so as to cause them to be moved rotationally in opposite directions. The interlock member 80 is connected to both of the first and second link pairs 52A and 52B so as to interconnect the first and second link pairs 52A and 52B.

Specifically, the interlock member 80 includes a first connection part and a second connection part, which are connected to the first and second link pairs 52A and 52B, respectively. The interlock member 80 according to this embodiment is formed of a plate-like member extending in a single direction, having opposite ends which correspond to the first and second connection parts, respectively.

The first connection part is pivotably connected to one first link member out of the first link pair 52A, specifically, the first inner link member 53A in this embodiment, through the pin 11I. The pin 11I according to this embodiment, thus, also serves as a first connection pivot which is a rotation axis of the first connection part, interconnecting the first inner link member 53A and the interlock member 80 so as to allow the first inner link member 53A and the interlock member 80 to pivot relatively to each other around the center axis of the pin 11I at the position closer to the pin 11E, which is the first arm-side pivot, than the pin 11A, which is the first body-side pivot of the first inner link member 53A, namely, the position lower than the pin 11A in FIG. 4.

The second connection part is pivotably connected to one second link member out of the second link pairs 52B, specifically, the second inner link member 53B in this embodiment, through the pin 11K. The pin 11K is a second connection pivot, which is a pivot of the second connection part, interconnecting the second inner link member 53B and the interlock member 80 so as to allow the second inner link member 53B and the interlock member 80 to pivot relatively to each other around the center axis of the pin 11K at the position farther from the pin 11G, which is the second arm-side pivot, than the pin 11B, which is the second body-side pivot of the second inner link member 53B, namely, the position on the upper side in FIG. 4. More specifically, the second inner link member 53B includes an upper protruding part with an upper end, to which the second connection part of the interlock member 80 is pivotably connected through the pin 11K. The upper protruding part is a part protruding upward beyond the pin 11B which is the second connection pivot in the inner link member 53B.

The interlock member 80 interlocks respective movements of the first and second link pairs 52A and 52B as follows. The expansion and contraction of the hydraulic cylinder constituting the driving device 70 moves the pins 11I and 11K, which are respective connection points between the driving device 70 and the first and second link pairs 52A and 52B, in the relatively opposite directions, thereby moving respective lower ends of the first and second inner link members 53A and 53B in the relatively opposite directions. The movement of the lower end of the first inner link member 53A in the opening and closing direction causes the entire interlock member 80 to be moved in the same direction as the movement, thereby causing the lower end of the second inner link member 53B to be moved in the opposite direction to the lower end of the first inner link member 53A. Similarly, the movement of the lower end of the second inner link member 53B in the opening and closing direction causes the entire interlock member 80 to be moved in the opposite direction to the movement, thereby causing the lower end of the first inner link member 53A to be moved in the opposite direction to the lower end of the second inner link member 53B.

The interlock member 80, thus, moves one of the first and second link pairs 52A and 52B in the opposite direction to the other along with the movement of the other in the opening and closing direction, thereby equalizing respective movement amounts of the first and second operation points, namely, the pin 11I and the pin 11J in this embodiment, caused by the expansion and contraction motions of the driving device 70. Without the interlock member 80, the movement amounts of the first and second operation points caused by the expansion and contraction motions of the driving device 70 would not be necessarily equal and the tilt of the holding apparatus 10 or other factors would cause the movement amount of one of the first and second operation that is likely to be moved to be greater than that of the other. This renders the movement amounts of the first and second link pairs 52A and 52B unequal. The interlock member 80 effectively reduces such unevenness in the movements.

Each of the first holding element 90A and the second holding element 90B is a part contactable with the carrying object 150 to hold the carrying object 150 that is the holding object. The first holding element 90A is pivotably mounted to the arm lower region 62 of the first arm 60A, and the second holding element 90B is pivotably mounted to the arm lower region 62 of the second arm 60B. Specifically, the first holding element 90A is connected to the lower end of the arm lower region 62 of the first arm 60A pivotably around a first holding pivot axis extending in the front-rear direction relatively to the first arm 60A. Similarly, the second holding element 90B is connected to the lower end of the arm lower region 62 of the second arm 60B pivotably around a second holding pivot axis extending in the front-rear direction relatively to the second arm 60B.

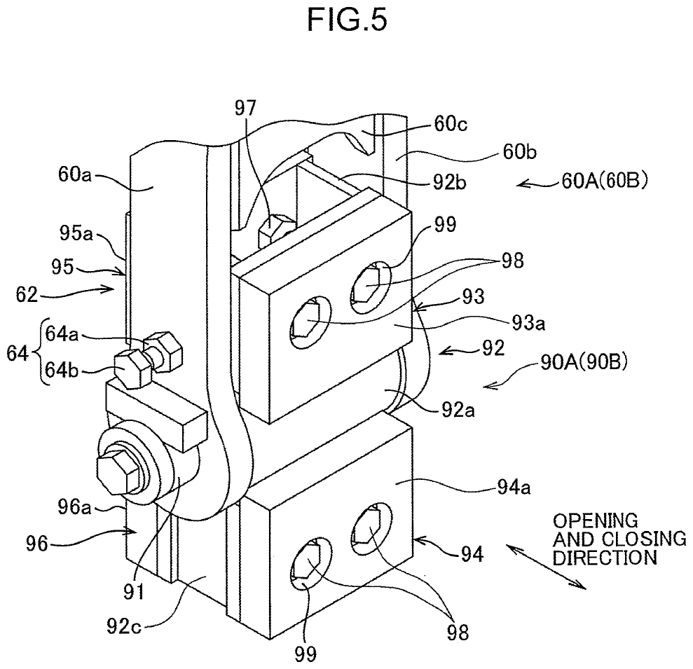

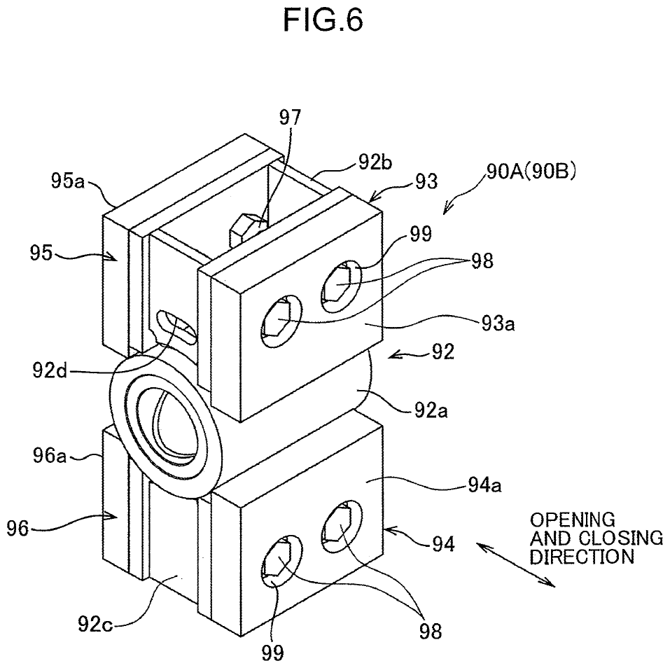

Respective specific structures of the first and second holding elements 90A and 90B are equivalent to each other. FIG. 5 shows a state where the first holding element 90A is supported by the arm lower region 62 of the first arm 60A and also shows a state where the second holding element 90B is supported by the arm lower region 62 of the second arm 60B. FIG. 6 shows only one of the first holding element 90A and the second holding element 90B alone.

Preferably, at least one of the first and second holding elements according to the present invention is a composite holding element that is constituted by a plurality of members. In the first embodiment, each of the first and second holding elements 90A and 90B is a composite holding element. Specifically, each of the first and second holding elements 90A and 90B includes a holding-element body 92, a pair of upper and lower inner contact members 93 and 94, and a pair of upper and lower outer contact members 95 and 96.

The holding-element body 92 is pivotably connected to the arm lower region 62 of the arm corresponding to the holding-element body 92 and selected from the first and second arms 60A and 60B. Specifically, the holding-element body 92 of the first holding element 90A is connected to the lower end of the arm lower region 62 of the first arm 60A pivotably around the first holding pivot axis, and the holding-element body 92 of the second holding element 90B is connected to the lower end of the arm lower region 62 of the second arm 60B pivotably around the second holding pivot axis.

The holding-element body 92 is disposed between the lower ends of the pair of arm plates 60a and 60b, which are a pair of support members included in the first and second arms 60A and 60B, respectively, and supported by the lower ends pivotably around the holding pivot axis, which is the first holding pivot axis or the second holding pivot axis. Specifically, the holding-element body 92 includes a supported part 92a and a pair of upper and lower contact-member holding parts 92b and 92c. The supported part 92a has a cylindrical shape around the center axis extending in the front-rear direction to allow a pin 91 to be inserted into the supported part 92a in the front-rear direction. The pin 91 has opposite ends projecting forward and backward beyond the supported part 92a, and the opposite ends are fixed to the pair of arm plates 60a and 60b, respectively. The holding-element body 92 is thereby supported by the pair of arm plates 60a and 60b through the pin 91 pivotably around the center axis of the pin 91, that is, around the first holding pivot axis or the second holding pivot axis, each of which extends in the front-rear direction.

The pair of contact-member holding parts 92b and 92c are arranged above and below the supported part 92a, respectively, and joined integrally with the supported part 92a. The upper contact-member holding part 92b of the pair of contact-member holding parts 92b and 92c holds the upper inner contact member 93 out of the pair of inner contact members 93 and 94 and the upper outer contact member 95 out of the pair of outer contact members 95 and 96, while the lower contact-member holding part 92c holds the lower inner contact member 94 out of the pair of inner contact members 93 and 94 and the lower outer contact member 96 out of the pair of outer contact members 95 and 96. Specifically, each of the pair of contact-member holding parts 92b and 92c illustrated in FIGS. 5 and 6 is formed of a hollow box body, having an inner holding surface facing inward in the opening and closing direction and an outer holding surface facing outward in the opening and closing direction.

Each of the inner contact members 93 and 94 and the outer contact members 95 and 96 has a plate shape, for example, as shown in FIGS. 5 and 6, and includes a contact surface contactable with the carrying object 150. The pair of inner contact members 93 and 94 are fixed to the inner holding surfaces of the pair of contact-member holding parts 92b and 92c, respectively, allowing the opposite surfaces of the pair of inner contact members 93 and 94 to the inner holding surfaces to serve as inner contact surfaces 93a and 94a, respectively. Similarly, the pair of outer contact members 95 and 96 are fixed to the outer holding surface of the pair of contact-member holding parts 92b and 92c, respectively, allowing the opposite surface of the pair of outer contact members 95 and 96 to the outer holding surface to serve as outer contact surfaces 95a and 96a, respectively. The inner contact surfaces 93a and 94a are surfaces opposed to the inner contact surfaces 93a and 94a of the counterpart holding element out of the first and second holding elements 90A and 90B, that is, surfaces facing inward in the opening and closing direction, being contactable with the carrying object 150 from the outside in the opening and closing direction. The outer contact surfaces 95a and 96a are surfaces facing the opposite sides to the inner contact surfaces 93a and 94a, respectively, that is, facing outward in the opening and closing direction, being contactable with the carrying object 150 from the inside in the opening and closing direction.

The holding-element body 92 is made of a material having higher rigidity than that of the material forming the inner and outer contact members 93 to 96, for example, a metal material. On the other hand, each of the inner and outer contact members 93 to 96 is made of a material having elasticity higher than that of the material forming the holding-element body 92, preferably an elastic body, for example, rubber. In summary, it is preferable that each of the inner and outer contact surfaces 93a and 94a and 95a, and 96a is formed of an elastic body.

The inner and outer contact members 93 to 96 are fastened to the contact-member holding parts of the pair of contact-member holding parts 92b and 92c, respectively, by a plurality of bolts 98 shown in FIGS. 5 and 6. Specifically, provided are a plurality of bolt insertion holes penetrating the inner and outer contact members 93 to 96, respectively, in the thickness direction thereof at respective appropriate positions, allowing the bolt 98 to be inserted in the bolt insertion hole from the outside and screwed into respective nuts 97 fixed to each of the pair of contact-member holding parts 92b and 92c. A part of the plurality of bolts 98 serve as inner fastening members to fasten the inner contact members 93 and 94 to the pair of contact-member holding parts 92b and 92c, and a remaining part of the bolts 98 serve as outer fastening members to fasten the outer contact members 95 and 96 to the pair of contact-member holding parts 92b and 92c.

Each of the inner and outer contact surfaces 93a to 96a is formed with a recess 99 around the bolt insertion holes. The recess 99 has a diameter and depth enough to accommodate the head of the bolt 98, thereby allowing the head of the bolt 98 to retract from each of the inner contact surfaces 93a and 94a outward in the opening and closing direction, that is, leftward in FIGS. 5 and 6, and allowing the head of the bolt 98 to retract from each of the outer contact surfaces 95a and 96a inward in the opening and closing direction, that is, rightward in FIGS. 5 and 6.

Preferably, at least one of the first and second arms according to the present invention is the pivot restricting arm. In the first embodiment, each of the first and second arms 60A and 60B is a pivot restricting arm, and each of the first and second holding elements 90A and 90B is a restricted holding element. The restricted holding element is a holding element whose pivot relative to the arm lower region 62 of the pivot restricting arm is restricted by the pivot restricting arm. Specifically, each of the first and second arms 60A and 60B has a pivot restricting part 64, which restricts the pivot of the corresponding holding element out of the first and second holding elements 90A and 90B relative to the arm lower region 62 of the first and second arms 60A and 60B, respectively, within a limited range.

The pivot restricting part 64 according to this embodiment includes a nut 64a and a bolt 64b as shown in FIG. 5. The nut 64a is fixed to the outer surface of the arm plate 60a. The nut 64a is located at a position near the lower end of the arm plate 60a, for example, at a position slightly above the pin 91 shown in FIG. 5. At the position is formed a bolt insertion hole passing through the arm plate 60a, matching with the nut 64a. The bolt 64b can be inserted into the nut 64a and the bolt insertion hole from the outside while screwed with the nut 64a. The degree of advance of the screw, that is, the rotation amount of the bolt 64b, corresponds to the protrusion dimension of the bolt 64b beyond the inner surface of the arm plate 60a, rendering the dimension adjustable.

Each of the first and second holding elements 90A and 90B is provided with a pivot restricted part that engages with the pivot restricting part 64 to thereby make the pivot thereof restricted. More specifically, the holding-element body 92 is formed with an elongated hole 92d shown in FIG. 6 at an appropriate position. The elongated hole 92d is formed at a position allowing the distal end of the bolt 64b to be fitted into the elongated hole 92d, and the engagement of the bolt 64b with the elongated hole 92d restricts the pivot of each of the first and second holding elements 90A and 90B to the arm lower region 62 within a limited range. The elongated hole 92d is, specifically, formed in an arc shape having a center on each of the first and second pivot axes, the center angle of the arc corresponding to the pivot angle limited by the pivot restricting part 64. Preferably, the pivot range is set so as to locate the first and second holding elements 90A and 90B in a normal posture as shown in FIGS. 2-6 at the center of the pivot range. The normal posture is a posture where each of the inner contact surfaces 93a and 94a and the outer contact surfaces 95a and 96a faces the opening and closing direction, that is, a posture where the normal direction of the contact surfaces 93a to 96a coincides with the opening and closing direction.

The bolt 64b may be disposed, in contrast to the structure shown in FIG. 5, so as to be inserted from the inside toward the outside of the pair of arm plates 60a and 60b. For example, it is also possible that the bolt 64b is screwed to each of the first and second holding elements 90A and 90B and one of the pair of arm plates 60a and 60b is formed with an elongated hole equivalent to the elongated hole 92d to allow the bolt 64b to be inserted thereinto from the inside. This allows the dimension of protrusion of the bolt 64b beyond the arm plate 60a or the arm plate 60b to thereby restrain the bolt 64b from contact with the carrying object 150.

As shown in FIGS. 2 and 4, the carrying object 150 to be held by the holding apparatus 10 has an upwardly opened shape, which includes an inner surface. The carrying object 150 illustrated in FIGS. 2 and 4 is a structure having a shape forming a U-shaped groove, with a uniform cross section with respect to the front-rear direction, that is, the depth direction in FIGS. 2 and 4. The holding object is not limited to a carrying object. The shape of the holding object is also not limited but permitted to be, for example, a box shape that is opened upward. The carrying object 150 illustrated in FIGS. 2 and 4 is made of, for example, concrete, and is, for example, precast concrete.

The carrying object 150 includes a bottom wall 152, a first side wall 154A, and a second side wall 154B, which are integrally formed with each other. Specifically, the bottom wall 152 extends along the front-rear direction. The first side wall 154A protrudes upward from one side of the bottom wall 152, and the second side wall 154B protrudes upward from the other side of the bottom wall 152. Accordingly, the first and second side walls 154A and 154B are spaced and opposed to each other in a width direction of the carrying object 150, and the bottom wall 152 interconnects respective bottom ends of the first and second side walls 154A and 154B in the width direction. The width direction is a direction perpendicular to each of the front-rear direction and the height direction, being a right-left direction in FIGS. 2 and 4. As for the structure constituting the U-shaped groove as the carrying object 150, there are a plurality of types of different specifications from each other. The specifications include, for example, the overall size, the widthwise dimension of the bottom wall 152, and the respective tilt angles of the outer and inner surfaces of the first and second side walls 154A and 154B.

The holding apparatus 10 is capable of holding the carrying object 150 from either the inside or the outside of the carrying object 150. Specifically, increasing the arm interval to make the interval between respective inner contact surfaces 93a and 94a of the first and second holding elements 90A and 90B (the surfaces opposed to each other in the opening and closing direction), namely, an inner contact surface interval, larger than the interval between respective outer surfaces of the first and second side walls 154A and 154B of the carrying object 150 as shown in FIG. 4 enables the inner contact surfaces 93a and 94a to be brought into contact with the outer surfaces from the outside in the width direction. In contrast, decreasing the arm interval to make the interval between respective outer contact surfaces 95a and 96a of the first and second holding elements 90A and 90B, namely, an outer contact surface interval, smaller than the interval between respective inner surfaces of the first and second side walls 154A and 154B of the carrying object 150 as shown in FIG. 2 enables the outer contact surfaces 95a and 96a to be brought into contact with the inner surfaces from the inside in the width direction.

Next will be described a specific action of the holding apparatus 10.

The work machine 100 can move the holding apparatus 10 to a target position by the motion of at least one of the lower traveling body 110, the upper turning body 120, the boom 136, the arm 138, and the rotation drive mechanism 140. The movement includes both translation and rotation. The holding apparatus 10 can make the opening and closing motion, in which the first and second arms 60A and 60B are moved in opposite directions along the opening and closing direction so as to change the arm interval and further the interval between the first and second holding elements 90A and 90B. The opening and closing motion may be performed either in accordance with an operation applied by an operator who operates the work machine 100 or under automatic control by the controller.

The opening and closing motion is carried out as follows. In the state shown in FIG. 2, expansion of the hydraulic cylinder constituting the driving device 70 moves the pin 11I, which is the first operating point of the driving device 70, outward in the opening and closing direction, that is, leftward in FIG. 2, thereby causing the first inner link member 53A of the first link pair 52A to pivot outward in the opening and closing direction, that is, in an opening direction, around the pivot axis of the upper end of the first inner link member 53A, that is, around the first body-side pivot, the center axis of the pin 11A. On the other hand, the pin 11J, which is the second operation point of the driving device 70 is moved outward in the opening and closing direction, that is, rightward in FIG. 2, in contrast to the pin 11I, thereby causing the second inner link member 53B of the second link pair 52B to pivot outward in the opening and closing direction, that is, in the opening direction, around the pivot axis of the upper end of the second inner link member 53B, that is, around the second body-side pivot, the center axis of the pin 11B. The pivot of the first inner link member 53A outward in the opening and closing direction causes the parallel link mechanism including the first link pair 52A to move the first arm 60A and the first holding element 90A connected thereto outward along the opening and closing direction (leftward in FIG. 2). Similarly, the pivot of the second inner link member 53B outward in the opening and closing direction causes the parallel link mechanism including the second link pair 52B to move the second arm 60B and the second holding element 90B connected thereto outward along the opening and closing direction (rightward in FIG. 2).

The movement of the pin 11I, which is the first operation point, outward in the opening and closing direction involves the movement of the entire interlock member 80 in the same direction, thereby moving the pin 11K, which interconnects the upper end of the interlock member 80 and the second inner link member 53B, in the same direction, i.e., leftward in FIG. 2. This causes the pivot of the second inner link member 53B around the pin 11B which is the second body-side pivot, i.e., the movement of the lower end of the second inner link member 53B outward in the opening and closing direction (rightward in FIG. 2), thereby moving the second arm 60B outward in the opening and closing direction, that is, rightward in FIG. 2. Meanwhile, the expansion of the driving device 70 involves the movement of the pin 11J, which is the second operation point, outward in the opening and closing direction (rightward in FIG. 2), which also causes the movement of the pin 11K and the entire interlock member 80 in the opposite direction, that is, leftward in FIG. 2. This causes the lower end of the first inner link member 53A to pivot around the pin 11A, which is the first body-side pivot, to cause the lower end of the first inner link member 53A to be moved outward in the opening and closing direction, that is, leftward in FIG. 2, thereby moving the first arm 60A connected to the first inner link member 53A outward in the opening and closing direction, that is, leftward in FIG. 2. The first and second arms 60A and 60B, thus, can be moved outward in the opening and closing direction, respectively, which allows the arm interval, which is the interval between the first and second arms 60A and 60B in the opening and closing direction, to be enlarged, for example, to the interval shown in FIG. 4.

Performing a closing motion, which is the reverse motion to the above-described outward motion in the opening and closing direction, namely, the opening operation, can decrease the arm interval, which is the interval between the first and second holding elements 90A and 90B in the opening and closing direction.

As described above, respective opposite pivots of the first and second inner link members 53A and 53B around the respective upper ends of the first and second inner link members 53A and 53B moves the pair of parallel link mechanisms including respective first and second inner link members 53A and 53B in opposite directions, resulting in the translation of respective arm upper regions 61 of the first and second arms 60A and 60B included in the pair of parallel link mechanism in opposite directions along the opening and closing direction. This allows the arm interval to be changed while keeping the first and second arms 60A and 60B in their respective predetermined holding posture, in which the arm lower region 62 extends downward from the arm upper region 61. Although the arm interval could be changed also by direct actuation of the first and second arms 60A and 60B in the direct opening and closing direction by the driving device 70 without the interposition of the opening and closing mechanism 50 including the first and second link pairs 52A and 52B, the interposition of the opening and closing mechanism 50 enables the arm interval to be changed with less movement of the driving device 70 while keeping each of the first and second arms 60A and 60B in the holding posture.

In addition, the interlock member 80 reliably interlocks the movement of one arm of the first and second arms 60A and 60B with the opposite movement of the other arm, thereby allowing the position for holding the carrying object 150 to be easily adjusted.

Specifically, the holding apparatus 10 can hold the carrying object 150 from either the inside or the outside in the following manner.

(A) Holding Carrying Target from Outside

For holding the carrying object 150 from the outer sides of the carrying object 150, as shown in FIG. 4, the interval between the first and second holding elements 90A and 90B in the opening and closing direction, more specifically, the inner contact surface interval between the inner contact surfaces 93a and 94a of the first holding element 90A and the inner contact surfaces 93a and 94a of the second holding element 90B, is enlarged to an interval larger than the interval between respective outer surfaces of the first and second side walls 154A and 154B of the carrying object 150 while keeping each of the first and second arms 60A and 60B in the holding posture. Lowering the thus operated holding apparatus 10 allows the first and second holding elements 90A and 90B to be located on respective outer sides of the outer surfaces of the carrying object 150.

In this condition, performing the closing motion, that is, moving the first and second arms 60A and 60B in the directions of decreasing the arm interval and the inner contact surface interval while keeping each of the first and second arms 60A and 60B in the holding posture, can bring the inner contact surfaces 93a and 94a of the first and second holding elements 90A and 90B into contact with respective outer surfaces of the first and second side walls 154A and 154B of the carrying object 150, respectively. This enables the carrying object 150 to be held by the holding apparatus 10 from the outer side in the width direction of the carrying object 150 so as to be sandwiched between the first and second holding elements 90A and 90B in the opening and closing direction.

Since the first and second holding elements 90A and 90B are allowed to pivot around the first and second holding pivot axes in the front and rear directions relative to the respective arm lower regions 62 of the first and second arms 60A and 60B, the inner contact surfaces 93a and 94a can tilt to the arm lower region 62 flexibly in correspondence with the tilt or shape of the outer surface for contact with the outer surface of the carrying object 150. This enables the inner contact surfaces 93a and 94a to come into contact with the outer surface of the carrying object 150 in a larger contact area. In detail, it is possible to increase the contact area between the outer surfaces of the carrying object 150 and the inner contact surfaces 93a and 94a of the first and second holding elements 90A and 90B as compared with the case of non-pivotably fixing the first and second holding elements 90A and 90B to the arm lower region 62. This enables the holding apparatus 10 to hold the carrying object 150 with sufficient holding force regardless of the slight tilts of the two outer surfaces of the carrying object 150.

The height positions at which the first and second holding elements 90A and 90B make contact with the outer surfaces of the carrying object 150 for holding the carrying object 150 can be freely set in the range from the upper end of the outer surface of the carrying object 150 (i.e., respective upper ends of the first and second side walls 154A and 154B) to the lower ends (respective lower ends of the first and second side walls 154A and 154B). For example, contact at a height position substantially equivalent to the gravity center position of the carrying object 150 renders the variation in the gravity center position small with the variation in the orientation of the carrying object 150 which is held by the holding apparatus 10, thereby enabling the carrying object 150 to be carried stably. Besides, the lower part of the carrying object 150, being close to the bottom wall 152 interposed between the first and second side walls 154A and 154B, has a higher strength than that of the upper part of the carrying object 150; therefore, sandwiching the lower part enables the carrying object 150 to be held while restrained from breakage.

The pivot restricting parts 64 restrict the pivots of the first and second holding elements 90A and 90B relative to the arm lower region 62 within a limited range, thereby restraining the first and second holding elements 90A and 90B from unnecessary swinging. This restrains regions of the first and second holding elements 90A and 90B other than the inner contact surfaces 93a and 94a from contacting the carrying object 150, thereby enabling the inner contact surfaces 93a and 94a to be easily brought into contact with the outer surfaces of the carrying object 150.

Kept in the holding posture during the opening and closing motion of the first and second arms 60A and 60B, each of the first and second holding elements 90A and 90B can be brought into contact with the carrying object 150 at constant angle regardless of the arm interval, which enables the holding apparatus 10 to hold the carrying object 150 with sufficient holding force. Besides, the inner contact surfaces 93a and 94a can be restrained from being tilted to the outer surface of the carrying object 150 beyond the adjustable range (the range limited by the pivot restricting part 64) by the pivots of the first and second holding elements 90A and 90B, which is kept in the holding posture, relative to the arm lower region 62.

The holding of the carrying object 150 from the outside of the carrying object 150 is useful when there are enough spaces on the outer sides of the carrying object 150 to allow the first and second holding elements 90A and 90B to enter the spaces. The first and second holding elements 90A and 90B located outside the carrying object 150 allows an operator to visually recognize respective relative positions of the first and second holding elements 90A and 90B to the outer surface of the carrying object 150. This allows the first and second holding elements 90A and 90B to be reliably positioned at a desired height position relative to the carrying object 150, e.g., a height position equivalent to the gravity center position of the carrying object 150 or a height position of the lower part of the carrying object 150, thereby enabling the carrying object 150 to be suitably held from the outer side of the carrying object 150.

(B) Holding from the Inside of the Carrying Object

For holding the carrying object 150 from the inner side of the carrying object 150, as shown in FIG. 2, the interval between the first and second holding elements 90A and 90B in the opening and closing direction, more specifically, the outer contact surface interval between the outer contact surfaces 95a and 96a of the first holding element 90A and the outer contact surfaces 95a and 96a of the second holding element 90B, is reduced to a smaller interval than the interval between respective inner surfaces of the first and second side walls 154A and 154B of the carrying object 150, i.e., the dimension of the upper end opening in the width direction, while keeping the first and second arms 60A and 60B in the holding posture. Lowering the thus operated holding apparatus 10 allows the first and second holding elements 90A and 90B to be located on respective inner sides of the inner surfaces of the carrying object 150.

In this condition, performing the opening motion, that is, moving the first and second arms 60A and 60B in the directions of increasing the arm interval and the outer contact surface interval while keeping each of the first and second arms 60A and 60B in the holding posture can bring the outer contact surfaces 95a and 96a of the first and second holding elements 90A and 90B into contact with respective inner surfaces of the first and second side walls 154A and 154B of the carrying object 150. This enables the carrying object 150 to be held by the holding apparatus 10 from the inner side in the width direction of the carrying object 150 so as to be pressed from the inside in the opening and closing direction by the first and second holding elements 90A and 90B.

Since the first and second holding elements 90A and 90B are allowed to pivot around the first and second holding pivot axes in the front and rear directions relative to the respective arm lower regions 62 of the first and second arms 60A and 60B, the outer contact surfaces 95a and 96a can tilt to the arm lower region 62 flexibly in correspondence with the tilt or shape of the inner surface for contact with the inner surface of the carrying object 150. This enables the outer contact surfaces 95a and 96a to come into contact with the inner surface of the carrying object 150 in a larger contact area. In detail, it is possible to increase the contact area between the inner surfaces of the carrying object 150 and the outer contact surfaces 95a and 96a of the first and second holding elements 90A and 90B as compared with the case of non-pivotably fixing the first and second holding elements 90A and 90B to the arm lower region 62. This enables the holding apparatus 10 to hold the carrying object 150 with sufficient holding force regardless of the slight tilts of the inner surfaces of the carrying object 150.

The height positions at which the first and second holding elements 90A and 90B make contact with the inner surfaces to hold the carrying object 150 can be freely set from the upper ends of the inner surface of the carrying object 150 (i.e., respective upper ends of the first and second side walls 154A and 154B) to the lower ends (respective lower ends of the first and second side walls 154A and 154B). For example, contact at a height position substantially equivalent to the gravity center position of the carrying object 150 renders the variation in the gravity center position small with the variation in the orientation of the carrying object 150 which is held by the holding apparatus 10, thereby enabling the carrying object 150 to be carried stably. Besides, the lower part of the carrying object 150, being close to the bottom wall 152 that interconnects the first and second side walls 154A and 154B, has a higher strength than the upper part of the carrying object 150; therefore, pressing the outer contact surfaces 95a and 96a against the lower part enables the carrying object 150 to be held while restrained from breakage.

The pivot restricting parts restrict the pivots of the first and second holding elements 90A and 90B relative to the arm lower region 62 within a limited range, thereby restraining the first and second holding elements 90A and 90B from unnecessary swinging. This restrains regions of the first and second holding elements 90A and 90B other than the outer contact surfaces 95a and 96a from contacting the carrying object 150, thereby enabling the outer contact surfaces 95a and 96a to be easily brought into contact with the inner surfaces of the carrying object 150.

Kept in the holding posture during the opening and closing motion, each of the first and second arms 60A and 60B enables the first and second holding elements 90A and 90B to be brought into contact with the carrying object 150 at a constant angle regardless of the arm interval, which enables the holding apparatus 10 to hold the carrying object 150 with sufficient holding force. Besides, the outer contact surfaces 95a and 96a can be restrained from being tilted to the inner surface of the carrying object 150 beyond the range adjustable (a range limited by the pivot restricting part 64) by the pivots of the first and second holding elements 90A and 90B, which is kept in the holding posture, relative to the arm lower region 62.

The holding of the carrying object 150 from the inside of the carrying object 150 is useful when there are not any space on the outer sides of the carrying object 150 enough to allow the first and second holding elements 90A and 90B to enter, for example, when the first side wall 154A of the carrying object 150 and the second side wall 154B of another carrying object 150 are close to each other in the width direction. Even when such spaces are absent, inserting the first and second holding elements 90A and 90B into the upward directed opening of the carrying object 150 from above enables the carrying object 150 to be well held from the inside of the carrying object 150.

The holding of the carrying object 150 from the inside of the carrying object 150 is also effective for placing the carrying object 150 in a narrow groove or the like having a width dimension substantially equivalent to the width dimension of the carrying object 150. In such a situation, the first and second holding elements 90A and 90B, if sandwiching the carrying object 150 from the outside of the carrying object 150, cannot enter the groove because of lack of sufficient space between the side surface of the groove and the outer surface of each of the first and second side walls 154A and 154B of the carrying object 150. Even if having successively entered, the first and second arms 60A and 60B could hits the side surface of the groove to collapse the groove when making opening motion to release the holding in the groove. In contrast, the carrying object 150 held from the inside of the carrying object 150 can be placed in the groove while being kept held. Besides, the motion for releasing the holding after the placement, which is the closing motion of making the first and second arms 60A and 60B close to each other, can involve no contact of the first and second holding elements 90A and 90B with the side surfaces of the grooves.

The carrying object 150, held by the holding apparatus 10, can be lifted and transported to a destination. At this time, the inner contact members 93 and 94 and the outer contact members 95 and 96 which constitute the inner contact surfaces 93a and 94a and the outer contact surfaces 95a and 96a, respectively, being formed of an elastic body with higher elasticity than that of the holding-element body 92, enables the carrying object 150 to be firmly held with use of the elastic restoring force of the inner and outer contact members 93 to 96.

When the carrying object 150 reaches the destination, the holding of the carrying object 150 by the holding apparatus 10 is released. Specifically, in the case where the first and second holding elements 90A and 90B hold the carrying object 150 from the outer sides of the carrying object 150, the opening motion is made in which the first and second arms 60A and 60B and the first and second holding elements 90A and 90B are moved away from each other in the opening and closing direction to release the holding of the carrying object 150. In contrast, in the case where the first and second holding elements 90A and 90B hold the carrying object 150 from the inner sides of the carrying object 150, the closing operation is made in which the first and second arms 60A and 60B and the first and second holding elements 90A and 90B are moved toward each other in the opening and closing direction to release the holding of the carrying object 150 by the holding apparatus 10.

The turning section 146 of the rotation drive mechanism 140 can change the opening and closing direction of the holding apparatus 10 by turning the holding-apparatus body around a turning axis orthogonal to the opening and closing direction and the front and rear direction, respectively, and thereby change the orientation of the carrying object 150 that is being held by the holding apparatus 10. This facilitates handling of the carrying object 150. For example, even when the orientation of the carrying object 150 to be placed at the destination is different from the orientation of the carrying object 150 that had been placed until held by the holding apparatus 10, the turning section 146 can easily change the orientation of the carrying object 150 held by the holding apparatus 10 by turning the holding apparatus 10, thereby enabling the carrying object 150 to be easily placed in the proper orientation.

Besides, the tilt section 144 of the rotation drive mechanism 140 can change the tilt of the holding apparatus 10 by moving the holding-apparatus body rotationally around the tilt axis parallel to the plane including the opening and closing direction and the front-rear direction (horizontal plane in the posture shown in FIG. 1) relatively to the work attachment 130 and thereby change the inclination of the carrying object 150 which is being held by the holding apparatus 10. This facilitates handling of the carrying object 150. For example, even when the carrying object 150 held by the holding apparatus 10 is inclined to the installation plane of the destination, the tilt section 144 allows the carrying object 150 to be easily installed at the destination regardless of the state of the destination, for example, the inclination of the ground, by changing the inclination of the carrying object 150 held by the holding apparatus 10 to the vertical direction.

The first embodiment described above can be modified, for example, as follows.

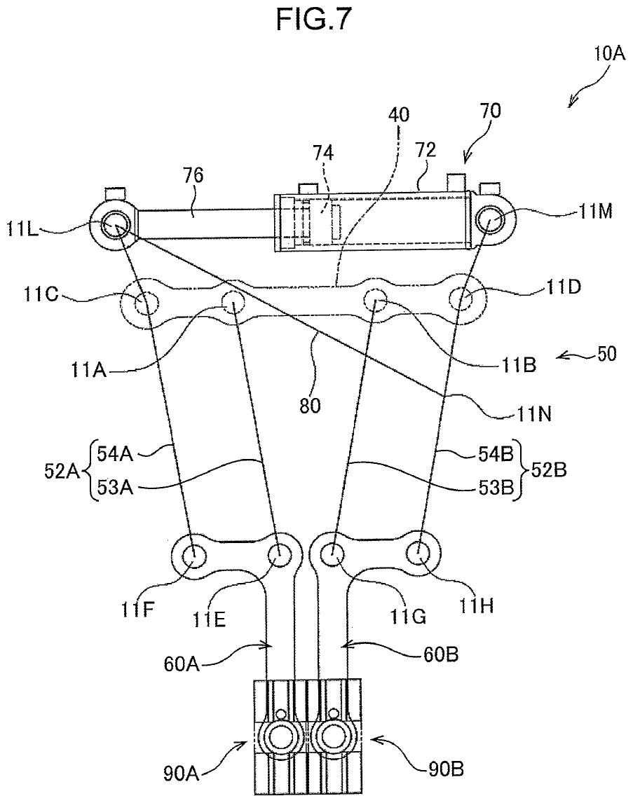

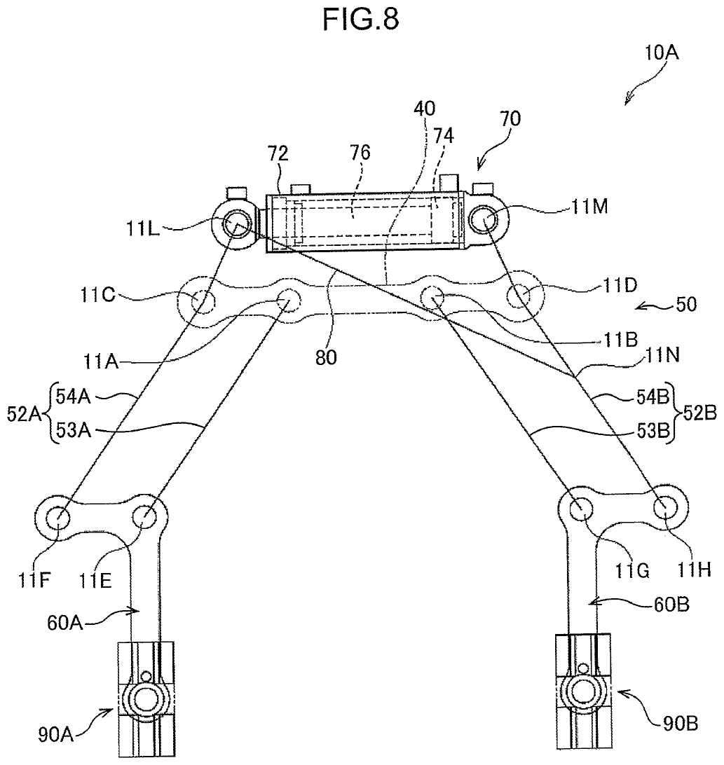

FIGS. 7 and 8 show a holding apparatus 10A according to a first modification of the first embodiment. In contrast to the first embodiment, the driving device 70 in this first modification is arranged so that the first and second arms 60A and 60B approaches each other in the opening and closing direction, that is, the arm interval is reduced, with the expansion of the hydraulic cylinder constituting the driving device 70 and so that the first and second arms 60A and 60B separates from each other in the opening and closing direction, that is, the arm interval is increased, with the contraction of the driving device 70.

Specifically, although the holding apparatus 10A includes an opening and closing mechanism 50 including a first and a second link pairs 52A and 52B similarly to the opening and closing mechanism 50 in the holding apparatus 10, the opposite ends of the driving device 70 are pivotably connected not to the first and second inner link members 53A and 53B but to respective upper ends of the first and second outer link members 54A and 54B in the first and second link pairs 52A and 52B through respective pins 11L and 11M. The pins 11L and 11M, thus, corresponds to the first operation point and the second operation point, respectively. Each of the first and second outer link members 54A and 54B is pivotally connected to the bar 40 through respective pins 11C and 11D at not the upper ends thereof but respective positions lower than the upper ends. The pins 11L and 11M, which are the first and second operating points, therefore, are located on respective sides farther from the pins 11F and 11H, which are first and second arm-side pivots, than the pins 11C and 11D, which are first and second body-side pivots, that is, on respective upper sides in FIG. 7. This allows the first and second outer link members 54A and 54B to pivot around the pins 11C and 11D in the closing and opening directions, respectively, with the expansion and contraction of the driving device 70.

Although the holding apparatus 10A includes an interlock member 80 similarly to the holding apparatus 10, the first connection part, which is one end of the interlock member 80, is pivotably connected to the upper end of the first outer link member 54A through the pin 11L at the first operation point on the upper side of the pin 11C, which is the first body-side pivot, that is, on the side farther from the pin 11F, which is the first arm-side pivot, than the pin 11C. The pin 11L, therefore, serves as both the first body-side pivot and the first connection pivot. The second connection part, which is the other end of the interlock member 80, is pivotably connected to the second outer link member 54B at a lower position than the pin 11D, which is the second body-side pivot, that is, at a position closer to the pin 11H, which is a second arm-side pivot, than the pin 11D, which is a second body-side pivot, through a pin 11N, which is a second connection pivot.

In the holding apparatus 10A shown in FIG. 7, the contraction of the hydraulic cylinder constituting the driving device 70 moves the pin 11L, which is the first operation point, rightward in FIG. 7, thereby moving the first outer link member 54A located on the left side in FIG. 2 rotationally around the center axis of the pin 11C, which is the first body-side pivot, in the opening direction (clockwise in FIG. 7), and moving the first arm 60A connected to the first outer link member 54A outward in the opening and closing direction, that is, leftward in FIG. 7. The rightward movement of the pin 11L, which is the first operation point, in FIG. 2 causes the entire interlock member 80 including the pin 11N to be moved rightward in FIG. 2. This moves the second outer link member 54B located on the right side of FIG. 7 rotationally around the center axis of the pin 11D, which is the second body-side pivot, in the opening direction (counterclockwise in FIG. 7), and moving the second arm 60B connected to the second outer link member 54B outward in the opening and closing direction, that is rightward in FIG. 7. Through the above-described action, the interval between the opening and closing direction of the first and second arms 60A and 60B, namely, the arm interval, is enlarged as shown in FIG. 8. Besides, through the opposite action thereto, the arm interval is reduced.

The holding apparatus 10A according to the first modification also exhibits the same effect as that of the holding apparatus 10.

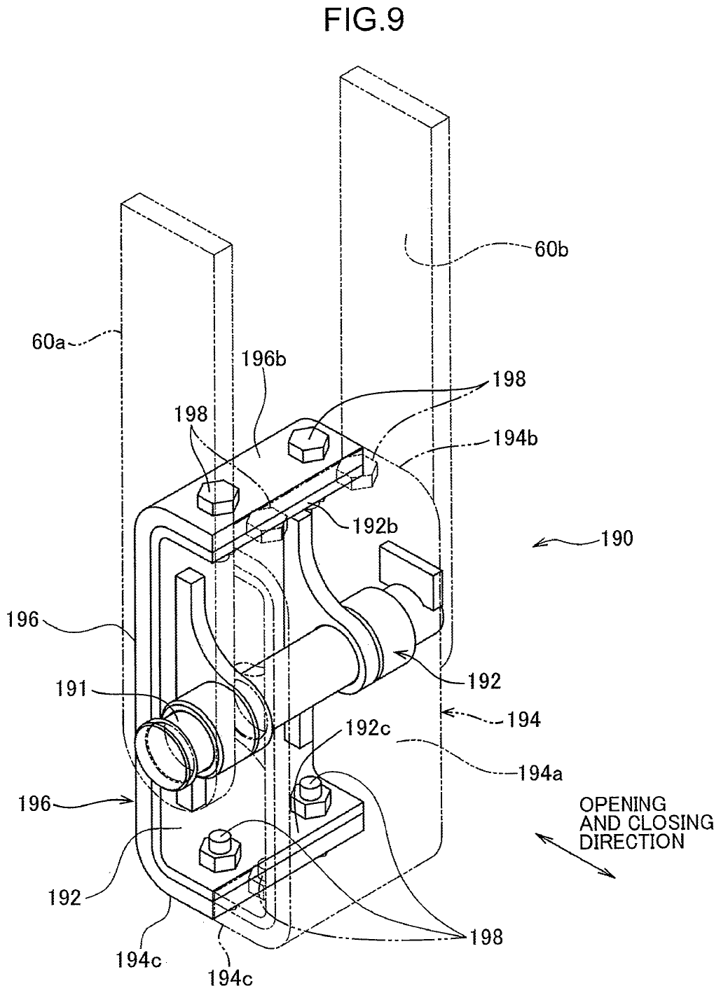

FIG. 9 shows a state where a holding element 190 according to a second modification of the first embodiment is attached to a pair of arm plates 60a and 60b constituting an arm lower region 62. The holding element 190 correspond to either modification of the first holding element 90A and the second holding element 90B.

As shown in FIG. 9, the holding element 190 includes a holding-element body 192, an inner contact member 194, and an outer contact member 196. In FIG. 9, the inner contact member 194 and the pair of arm plates 60a and 60b are indicated by two-dot chain lines. The holding-element body 192, similarly to the holding-element body 92, is supported by the pair of arm plates 60a and 60b through a pin 191 extending in the front-rear direction, pivotably around a holding pivot axis, which is the center axis of the pin 191 (namely, a first holding pivot axis or a second holding pivot axis). The inner contact member 194 is a member integrally formed of the inner contact members 93 and 94 according to the first embodiment, being composed of a plate-shaped elastic body like the inner contact members 93 and 94. Similarly, the outer contact member 196 is a member integrally formed by the outer contact members 95 and 96 according to the first embodiment, being composed of a plate-shaped elastic body similarly to the outer contact members 95 and 96.

The inner contact member 194 includes a main body part including an inner contact surface 194a contactable with a holding object, and a pair of extension parts 194b and 194c that are extended upward and downward from the main body part, respectively. The inner contact member 194 is bent so as to lay the extension parts 194b and 194c along a top wall 192b and a bottom wall 192c of the holding-element body 192, respectively, and the extension parts 194b and 194c are fastened vertically to the top wall 192b and the bottom wall 192c through a plurality of bolts 198 that are inner fastening members. Similarly, the outer contact member 196 includes a main body part including an outer contact surface 196a contactable with a holding object, and extension parts 196b and 196c that are extended upward and downward from the main body part, respectively. The outer contact member 196 is bent so as to lay the extension parts 196b and 196c along the top wall 192b and the bottom wall 192c of the holding-element body 192, respectively, and the extension parts 196b and 196c are vertically fastened to the top wall 192b and the bottom wall 192c, respectively, through a plurality of bolts 198 that are outer fastening members.

This structure enables the inner fastening member to be retracted outward in the opening and closing direction from the inner contact surface 194a, and enables the outer fastening member to be retracted inward in the opening and closing direction from the outer contact surface 196a, as in the first embodiment. In addition, the extension parts 194b, 194c, 196b, and 196c to be fastened to the holding-element body 192 are deviated parts from the main body parts forming the inner contact surface 194a and the outer contact surface 196a, respectively, which allows the inner contact surface 194a and the outer contact surface 196a to have respective increased areas, for example, as compared with the structures shown in FIGS. 5 and 6.

Next will be described a second embodiment of the present invention with reference to the drawings. In the following description, a description of a configuration common to the first embodiment and an effect produced thereby will be omitted, and mainly will be described points different from the first embodiment. Specifically, the elements of the holding apparatus according to the second embodiment are the same as the constituent elements of the holding apparatus 10 according to the first embodiment except for the pivot restricting part; hence, the same reference numerals are given to the constituent elements other than the pivot restricting part, and the description thereof is omitted.

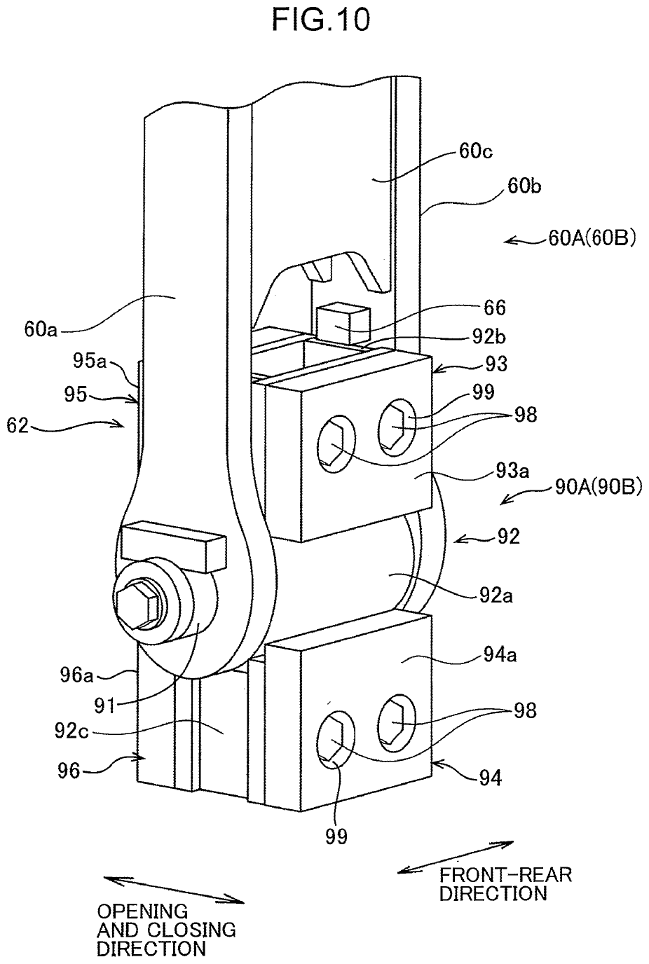

Each of the first and second arms 60A and 60B according to the second embodiment is also a pivot restricting arms; however, the pivot restricting part includes a restricting projection 66 shown in FIG. 10 in place of the pivot restricting part 64 shown in FIG. 5. The restricting projection 66 is disposed between a pair of arm plates 60a and 60b constituting the arm lower region 62 of each of the first and second arms 60A and 60B, i.e., a pair of support members in the front-rear direction.

The restricting projection 66 projects in the front-rear direction from one of the pair of arm plates 60a and 60b, specifically, the arm plate 60b on the back side in the example shown in FIG. 10, toward the other, specifically, the arm plate 60a on the front side in FIG. 10. The restricting projection 66 shown in FIG. 10 has a prismatic shape having a square cross section. The specific shape of the restricting projection, however, is not limited. The restricting projection may have a prismatic shape having a polygonal cross-section or a round column shape.

As shown in FIG. 10, the position of the restricting projection 66 is set so as to secure a gap having an appropriate vertical dimension between the bottom surface of the restricting projection 66 and the top surface of each of the first and second holding elements 90A and 90B when each of the first and second holding elements 90A and 90B, which is the restricting target, is in the normal posture. The normal posture is a posture where each of the inner contact surfaces 93a and 94a and the outer contact surfaces 95a and 96a faces the opening and closing direction, that is, a posture where the normal direction of the contact surfaces 93a to 96a coincides with the opening and closing direction. The pivot of each of the first and second holding elements 90A and 90B relative to the arm lower region 62 is allowed by the amount of the gap. The first and second holding elements 90A and 90B are prevented from pivoting beyond the position at which the upper surface of each of the first and second holding elements 90A and 90B abut against the restricting projection 66 along with large rotational movement of the first and second holding elements 90A and 90B from the normal posture. The restricting projection 66, thus, limits the pivot angle of each of the first and second holding elements 90A and 90B to the arm lower region 62 by abutment against the upper surface of each of the first and second holding elements 90A and 90B.

The restricting projection 66, disposed on the inner side of the pair of arm plates 60a and 60b, which are a pair of support members, in the front-rear direction, can be restrained from coming into contact with the carrying object 150 or the like, for example, as compared with a pivot restricting part disposed on the outer side of the pair of arm plates 60a and 60b. This allows the restricting projection 66 to be restrained from breakage.

In addition, the restricting projection 66 can reliably limit the pivot angle of each of the first and second holding elements 90A and 90B to the arm lower region 62 with a simple configuration that is only required to be capable of abutting against the upper surfaces of the first and second holding elements 90A and 90B.

Besides, the restricting projection 66 only required to be capable of abutting against the first and second holding elements 90A and 90B has a higher degree of freedom of shape, for example, than the bolt 64b constituting the pivot restricting part 64 shown in FIG. 5; this allows the restricting projection 66 to be designed to have a sufficient strength against the pivot of the first and second holding elements 90A and 90B. This enables the carrying object 150 to be held securely, for example, only by the lower regions of the first and second holding elements 90A and 90B.

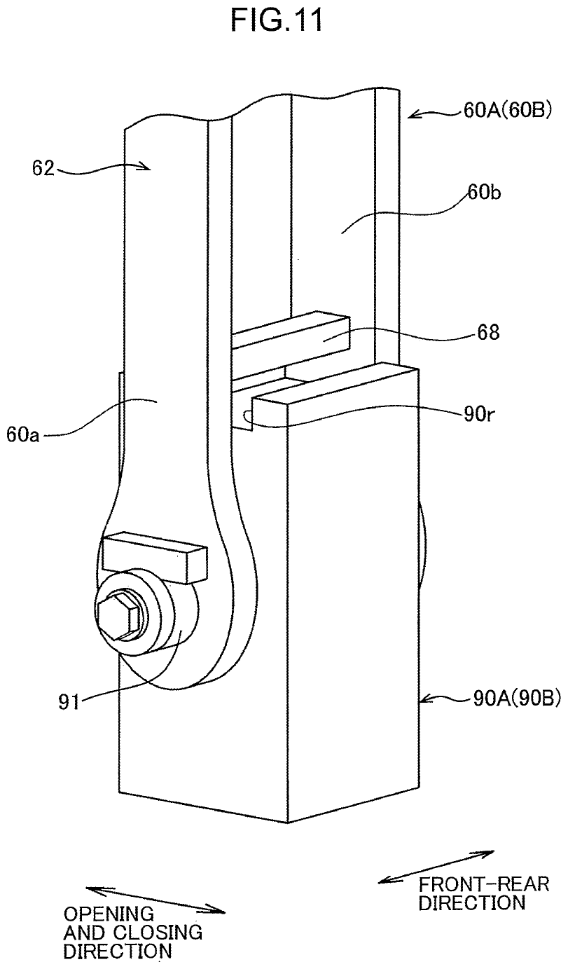

FIG. 11 shows a pivot restricting part according to a first modification of the second embodiment. The pivot restricting part includes an interconnection member 68, which is disposed so as to interconnect the pair of arm plates 60a and 60b, which is a pair of support members, in the front-rear direction at a position on the upper side of the first and second holding elements 90A and 90B. Similarly to the restricting projection 66, the interconnection member 68 can abut against the upper surface of each of the first and second holding elements 90A and 90B to thereby restrict the pivot of each of the first and second holding elements 90A and 90B relative to the arm lower region 62 within a limited range. On the other hand, each of the first and second holding elements 90A and 90B is formed with a recess 90r in the center part with respect to the opening and closing direction. The recess 90r is formed for reliably avoidance from interference with the interconnection member 68, being optional.

The interconnection member 68 can be designed to have a higher strength, for example, than that of the bolt 64b shown in FIG. 5. This enables the carrying object 150 to be securely held only by the lower region of the first and second holding elements 90A and 90B. In addition, the interconnection member 68, interconnecting the pair of arm plates 60a and 60b which is the pair of support members, can also serve as a reinforcing member for enhancing the strength of the arm lower region 62.

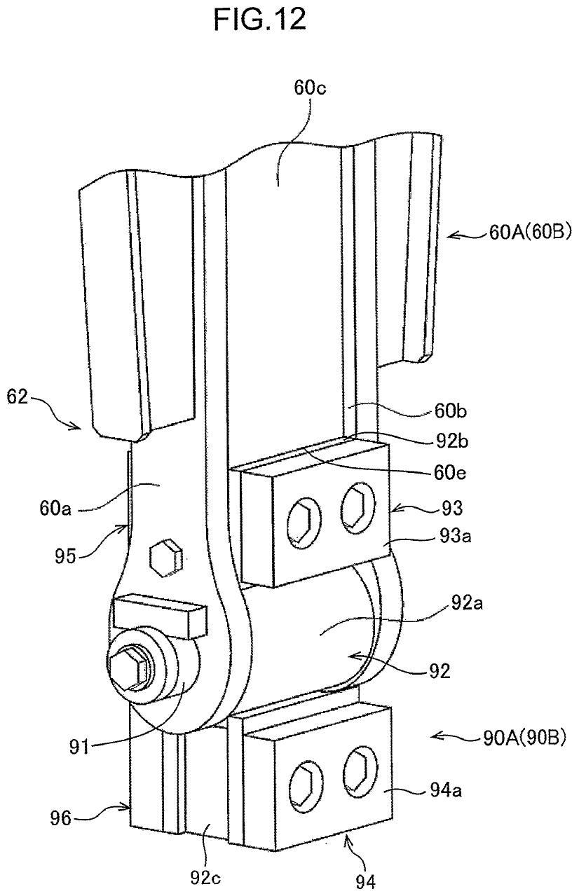

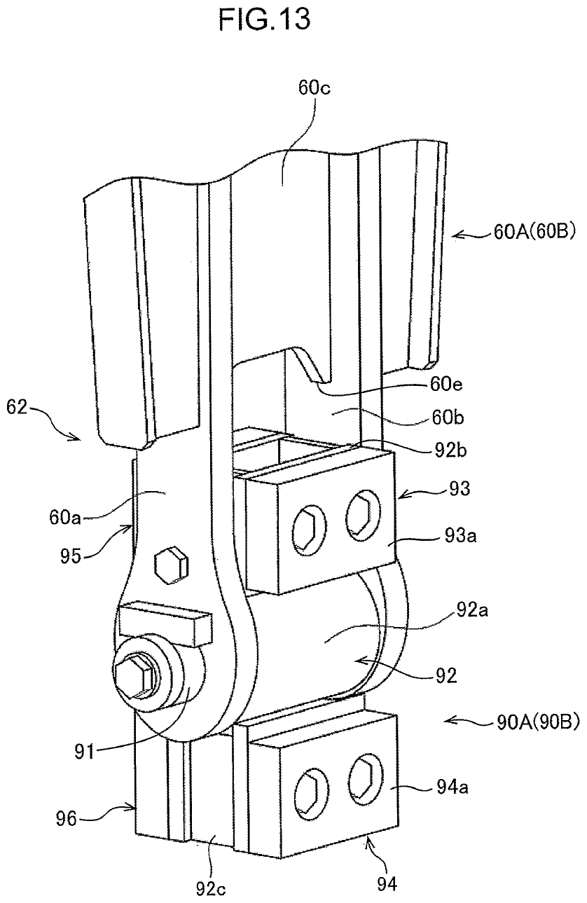

FIG. 12 shows a pivot restricting part according to a second modification of the second embodiment. As the pivot restricting part, a reinforcing plate 60c is utilized which is the same as the reinforcing plate 60c shown in FIGS. 2 to 5. The reinforcing plate 60c is originally a member interconnecting a pair of arm plates 60a and 60b, that is, a pair of support members, while extending vertically, to reinforce the arm lower region 62; in addition, the reinforcing plate 60c is extended downward to locate the lower end 60e of the reinforcing plate 60c at a position, for example, lower than the lower end 60e of the reinforcing plate 60c in the reference example shown in FIG. 13 and in the vicinity of the upper surface of the first and second holding elements 90A and 90B as shown in FIG. 12 lower than the position of the lower end 60e of the reinforcing plate 60c, thereby being utilized as a member constituting the pivot restricting part. This utilization allows the number of components of the first and second arms 60A and 60B to be reduced.

It is preferable that at least one of the first and second holding elements 90A and 90B is a low gravity-center holding element. The low gravity-center holding element has a center of gravity located lower than the pivot axis of the low gravity-center holding element (that is, the first holding pivot axis in the first holding element 90A or the second holding pivot axis in the second holding element 90B). For example, in the first holding element 90A (second holding element 90B) shown in FIG. 10, the wall of the holding-element body 92 constituting the lower contact-member holding part 92c is given a wall thickness larger than the wall thickness of the wall constituting the upper contact-member holding part 92b, whereby a larger mass is given to the part below the center axis of the pin 91, which is the pivot axis, than the mass of the part above the center axis. The low gravity-center holding element having the center of gravity thus lowered beyond the first or second holding pivot axis can be kept in a normal posture where the contact surfaces 93a to 96a face the opening and closing direction in FIG. 10 by its own weight to thereby allow the contact surfaces 93a to 96a to make favorable contact with the carrying object 150.

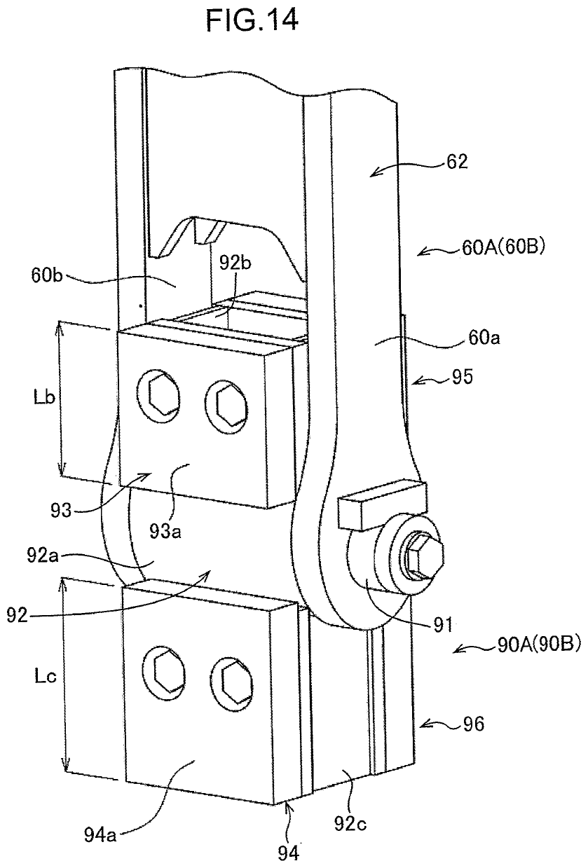

The means for making the position of the center of gravity lower than the first or second holding pivot axis is not limited to the setting of the wall thickness, and can be performed, for example, also by setting the vertical dimension. In the first holding element 90A (second holding element 90B) shown in FIG. 14, the center of gravity thereof is lowered to a position below the pivot axis by giving a larger vertical dimension Lc to the lower inner contact member 94 and the outer contact member 96 than the vertical dimension Lb of the upper inner contact member 93 and the outer contact member 95. Alternatively, it is also possible to attach a weight for adjusting the center of gravity only to a part of the first holding element 90A (the second holding element 90B) lower than the pivot axis thereof. In any case, the low gravity-center holding element configured to have the center of gravity below the pivot axis can be kept in a normal posture by its own weight, in which posture the inner contact surface and the outer contact surface of the low-gravity-center holding element can be easily brought into contact with a holding object such as the carrying object 150 placed on the ground, regardless of the inclination of the holding apparatus 10 to the ground.

The embodiments of the present invention and variations thereof having been described are merely specific examples, and the present invention is not particularly limited, and specific configurations and the like can be appropriately changed in design. In addition, the action and effect described in the embodiment of the invention are merely listed the most suitable action and effect resulting from the present invention, and the action and effect according to the present invention are not limited to those described in the embodiment of the present invention.

For example, the opening and closing mechanism according to the invention is not limited to one including the first and second link pairs 52A and 52B to constitute respective parallel link mechanisms. The opening and closing mechanism may include, for example, a guide rail extending in the opening and closing direction and a pair of sliders provided to the first and second arm, respectively. The guide rail is fixed to the holding-apparatus body and supports the first and second arms through the pair of sliders slidably in the opening and closing direction. The sliding of the first and second arms along the guide rail in the opening and closing direction also allows the interval between the first and second arms in the opening and closing direction, namely, the arm interval, to be changed.

The driving device according to the present invention is not limited to one capable of expansion and contraction motions such as a hydraulic cylinder or an electric cylinder. The driving device may be, for example, a motor that rotates the first and second link members around the first and second body-side pivot, respectively.

Respective materials to form the inner contact surface and the outer contact surface according to the present invention are not limited. For example, at least one of the inner contact surface and the outer contact surface may be formed of a metal material. Besides, it is preferable that at least one of the inner contact surface and the outer contact surface has a slippage prevention structure including unevenness, which may include, for example, a large number of projections, or may be formed with a large number of notches. The slippage prevention structure can restrain the holding object held by the holding apparatus from slipping off the first holding element or the second holding element.

In addition to the holding from the inside and the holding from the outside, other holding may be performed on the holding object, namely, the carrying object 150 in the above embodiment. For example, it is also possible that the inner contact surfaces 93a and 94a of the first and second holding elements 90A and 90B make contact with the outer surface and the inner surface of the first side wall 154A or the second side wall 154B of the carrying object 150, respectively, to sandwich the first side wall 154A or the second side wall 154B. This holding is useful for the case where the interval between the first side wall 154A and the second side wall 154B in the widthwise direction of the carrying object 150 is too large to allow the carrying object 150 to be easily held from the inside or the outside.

As described above, a holding apparatus and a work machine including the holding apparatus are provided, wherein the holding apparatus is provided on the work machine and capable of both holding a holding object from the outside thereof and holding a holding object from the inside thereof with sufficient holding force flexibly in correspondence with the shape of the holding object.

The holding apparatus is capable of holding a holding object while being connected to a distal end of an attachment body of the work machine comprising the attachment body that has the distal end and is operable to move the distal end, the holding apparatus and the attachment body constituting a work attachment. The holding apparatus includes a holding-apparatus body, a first arm, a second arm, an opening and closing mechanism, a driving device, a first holding element, and a second holding element. The holding-apparatus body is connectable to the distal end of the attachment body. The first arm and the second arm are aligned in an opening and closing direction. Each of the first arm and the second arm includes an arm upper region connected to the holding-apparatus body and an arm lower region extending downward from the arm upper region in a holding posture. The opening and closing mechanism is interposed between the holding-apparatus body and the arm upper region of each of the first arm and the second arm. The opening and closing mechanism connects the arm upper region of each of the first arm and the second arm to the holding-apparatus body so as to allow each of the first arm and the second arm to be translated in the opening and closing direction while keeping the first arm and the second arm in the holding posture to the holding-apparatus body. The holding posture is a posture where the arm lower region extends downward from the arm upper region. The driving device actuates the opening and closing mechanism to change an arm interval. The arm interval is an interval between the first arm and the second arm in the opening and closing direction. The first holding element is connected to the arm lower region of the first arm pivotably around a first holding pivot axis extending in a front-rear direction perpendicular to each of a vertical direction of the holding apparatus and the opening and closing direction. The second holding element is connected to the arm lower region of the second arm pivotably around a second holding pivot axis extending in the front-rear direction. The first holding element and the second holding element have respective inner contact surfaces opposed to each other in the opening and closing direction and respective outer contact surfaces facing opposite sides to the inner contact surfaces, respectively, with respect to the opening and closing direction.

According to the holding apparatus, increasing the arm interval to make the interval between the inner contact surfaces of the first and second holding elements larger than the interval between the outer surfaces of the holding object enables the first and second holding elements to sandwich the holding object, that is, to hold the holding object from both the outer sides thereof. In contrast, reducing the arm interval to make the interval between the outer contact surfaces of the first and second holding elements smaller than the interval between the inner surfaces of the holding object enables the outer contact surfaces to be pressed against the inner surfaces of the holding object, respectively, to hold the holding object from the inside. In addition, the first and second holding elements, which are pivotable around the first and second holding pivot axes in the front-rear direction relatively to the lower regions of the arms of the first and second arms, respectively, allows the inner contact surfaces and the outer contact surfaces of the first and second holding elements to make contact with the outer surfaces or the inner surfaces of the holding object over larger contact areas than that where the first and second holding elements are non-pivotable. This enables the holding apparatus to hold the holding object with sufficient holding force flexibly in correspondence with the tilt of the outer surface or the inner surface of the holding object. Besides, the opening and closing mechanism allows each of the first and second arms to be kept in the holding posture where the arm lower region extends downward from the upper arm, regardless of the change in the arm interval, thereby enabling the holding object to be held with sufficient holding force regardless of the arm interval.

Preferably, the opening and closing mechanism includes a pair of first link members arranged in parallel with each other between the first arm and the holding-apparatus body, and a pair of second link members arranged in parallel with each other between the second arm and the holding-apparatus body. The pair of first link members are connected to the holding-apparatus body pivotably around respective first body-side pivots extending in the front-rear direction and connected to the arm upper region of the first arm pivotably around respective first arm-side pivots extending in the front-rear direction so as to constitute a parallel link mechanism in cooperation with the holding-apparatus body and the arm upper region of the first arm. The pair of second link members are connected to the holding-apparatus body pivotably around respective second body-side pivots extending in the front-rear direction and connected to the arm upper region of the second arm pivotably around respective second arm-side pivots extending in the front-rear direction so as to constitute a parallel link mechanism in cooperation with the holding-apparatus body and the arm upper region of the second arm. The driving device rotationally actuates the pair of the first link members and the pair of second link member in opposite directions to each other relatively to the holding-apparatus body to thereby change the arm interval. The opening and closing mechanism, including the pair of first link members and the pair of second link members each constituting a parallel link mechanism, enables the first and second arms to be translated in the opening and closing direction while kept in their respective holding postures, with a simple movement of the driving device.

In this aspect, it is preferable that the holding apparatus further includes an interlock member that interconnects the pair of first link members and the pair of second link members so as to interlock the pair of first link members and the pair of second link members so that the pair of first link members and the pair of second link members are rotationally moved in opposite directions. The interlock member includes a first connection part and a second connection part. The first connection part is connected to one of the pair of first link members pivotably around a first connection pivot located on a side closer to the first arm-side pivot than the first body-side pivot. The second connection part is connected to one of the pair of second link members pivotably around a second connection pivot located on a side farther from the second arm-side pivot than the second body-side pivot.

The interlock member enables the first arm and the second arm to be moved in opposite directions with respect to the opening and closing direction so as to be reliably interlocked along with the operation of the driving device. This allows the position at which the holding apparatus holds the holding object to be easily adjusted.

It is preferable that at least one of the first arm and the second arm is a pivot restricting arm including a pivot restricting part, which restricts a pivot of a restricted holding element relative to the pivot restricting arm within a limited range, the restricted holding element being a holding element selected from the first holding element and the second holding element and connected to the pivot restricting arm. The pivot restricting part restrains the restricted holding element from unnecessary swing, thereby allowing the inner contact surface and the outer contact surface to be brought into contact with the holding object more easily.

More specifically, it is preferable that the arm lower region of the pivot restricting arm has a pair of support members disposed on both sides of the restricted holding element in the front-rear direction to pivotably support the restricted holding element, the pivot restricting part being disposed between the pair of support members in the front-rear direction. This can reduce the possibility of accidental contact of the pivot restricting part with an object other than the holding apparatus, for example, the holding object.

It is preferable, for example, that the pivot restricting part is configured to abut against an upper surface of the restricted holding element along with the pivot of the restricted holding element to thereby restrict the pivot of the restricted holding element within the limited range. The pivot restricting part can reliably limit the range of the pivot with a simple configuration only required to be capable of abutting against the upper surface.

More specifically, the pivot restricting part may include either a restricting projection that projects from an inner surface of at least one of the pair of supporting members in the front-rear direction or an interconnection member that interconnects the pair of supporting members on an upper side of the restricted holding element. The interconnection member, interconnecting the pair of supporting members, can also serve as a reinforcing member for reinforcing the arm lower region including the pair of supporting members.

It is preferable that at least one of the first holding element and the second holding element is a low gravity-center holding element, which has a center of gravity located below a pivot axis of the low gravity-center holding element out of the first holding pivot axis and the second holding pivot axis. The low-gravity-center holding element can be kept in a stable posture, regardless of the inclination of the entire holding apparatus, by effective utilization of its own weight.

It is preferable that each of the inner contact surface and the outer contact surface of at least one of the first holding element and the second holding element is formed of an elastic body. The elastic restoring force of the elastic body can be utilized for more securely holding the holding object.

It is preferable that each of the inner contact surface and the outer contact surface of at least one of the first holding element and the second holding element has a slippage prevention structure. The slippage prevention structure can prevent the holding object from slipping off the inner contact surface or the outer contact surface.

It is preferable that at least one of the first holding element and the second holding element is a composite holding element, which includes a holding-element body connected to the arm lower region of an arm corresponding to the composite holding element out of the first arm member and the second arm member, an inner contact member including the inner contact surface and fixed to the holding-element body, and an outer contact member including the outer contact surface comprising and fixed to the holding-element body. The composite holding element allows respective materials of the holding element body, the inner contact member and the outer contact member to be selected independently of each other.

For example, it is preferable that the holding-element body is made of a material having higher rigidity than that of respective materials forming the inner contact member and the outer contact member and that the material forming each of the inner contact member and the outer contact member has elasticity higher than that of the material forming the holding-element body. This enables the holding apparatus to hold the holding object more reliably with use of the high elasticity of each of the inner contact member and the outer contact member while ensuring a high rigidity of the entire composite holding element by the holding part body.

It is preferable that the composite holding element further includes an inner fastening member that fastens the inner contact member with the holding-element body at a position retracted outward from the inner contact surface in the opening and closing direction. This enables the inner fastening member to fix the inner contact member to the holding-element body without hindering good contact between the inner contact surface and the holding object.

Similarly, it is preferable that the composite holding element further includes an outer fastening member that fastens the outer contact member with the holding-element body at a position retracted inward from the outer contact surface in the opening and closing direction. This enables the outer fastening member to fix the outer contact member to the holding-element body without hindering good contact between the outer contact surface and the holding object.

Besides, the work machine to be provided includes an attachment body and the above-described holding apparatus. The attachment body has a distal end and is operable to move the distal end. The holding apparatus is configured to hold the holding object while being connected to the distal end of the attachment body to constitute a work attachment in cooperation with the attachment body.

In the work machine, preferably, the work attachment further includes a turning device interposed between the distal end of the holding-apparatus body and the attachment body of the holding apparatus. The turning device is configured to turn the holding-apparatus body relatively to the attachment body around a turning axis perpendicular to each of the opening and closing direction and the front-rear direction, thereby allowing the orientation of the holding object that is being held by the holding apparatus to be easily changed.

Besides, preferably, the work attachment further includes a tilt device interposed between the holding-apparatus body of the holding apparatus and the distal end of the attachment body. The tilting device moves the holding-apparatus body rotationally around a tilt axis relatively to the attachment body, thereby tilting the holding-apparatus body to the attachment body. The tilt axis is parallel to a plane including the opening and closing direction and the front-rear direction. The tilting device allows the inclination of the holding object that is being held by the holding apparatus to be easily changed, thereby facilitating handling of the holding object.

This application is based on Japanese Patent application No. 2020-204194 filed on Dec. 9, 2020 and No. 2021-120200 filed on Jul. 21, 2021 in Japan Patent Office, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A holding apparatus capable of holding a holding object while being connected to a distal end of an attachment body of a work machine to constitute a work attachment in cooperation with the attachment body, the attachment body having the distal and being operable to move the distal end, the holding apparatus comprising:
a holding-apparatus body connectable to the distal end of the attachment body;
a first arm and a second arm aligned in an opening and closing direction, each of the first arm and the second arm having an arm upper region connected to the holding-apparatus body and an arm lower region extending downward from the upper arm region in a holding posture;
an opening and closing mechanism interposed between the holding-apparatus body and the arm upper region of each of the first arm and the second arm so as to allow each of the first arm and the second arm to be translated in the opening and closing direction while kept in the holding posture to the holding-apparatus body, the holding posture being a posture where the arm lower region extends downward from the arm upper region;
a driving device that actuates the opening and closing mechanism so as to change an arm interval, which is an interval between the first arm and the second arm in the opening and closing direction;
a first holding element connected to the arm lower region of the first arm pivotably around a first holding pivot axis extending in a front-rear direction perpendicular to each of a vertical direction of the holding apparatus and the opening and closing direction;
a second holding element connected to the arm lower region of the second arm pivotably around a second holding pivot axis extending in the front-rear direction, wherein
the first holding element and the second holding element have respective inner contact surfaces opposed to each other in the opening and closing direction and respective outer contact surfaces facing opposite sides to the inner contact surfaces, respectively, with respect to the opening and closing direction.

2. The holding apparatus according to claim 1, wherein: the opening and closing mechanism includes a pair of first link members arranged in parallel with each other between the first arm and the holding-apparatus body, and a pair of second link members arranged in parallel with each other between the second arm and the holding-apparatus body; the pair of first link members are connected to the holding-apparatus body pivotably around respective first body-side pivots extending in the front-rear direction and connected to the arm upper region of the first arm pivotably around respective first arm-side pivots extending in the front-rear direction so as to constitute a parallel link mechanism in cooperation with the holding-apparatus body and the arm upper region of the first arm; the pair of second link members are connected to the holding-apparatus body pivotably around respective second body-side pivots extending in the front-rear direction and connected to the arm upper region of the second arm pivotably around respective second arm-side pivots extending in the front-rear direction so as to constitute a parallel link mechanism in cooperation with the holding-apparatus body and the arm upper region of the second arm; and the driving device rotationally actuates the pair of the first link members and the pair of second link member in opposite directions relatively to the holding-apparatus body to thereby change the arm interval.

3. The holding apparatus of claim 2, further comprising an interlock member that interconnects the pair of first link members and the pair of second link members so as to interlock the pair of first link members and the pair of second link members so that the pair of first link members and the pair of second link members are rotationally moved in opposite directions, wherein: the interlock member includes a first connection part and a second connection part; the first connection part is connected to one of the pair of first link members pivotably around a first connection pivot located on a side closer to the first arm-side pivot than the first body-side pivot; and the second connection part is connected to one of the pair of second link members pivotably around a second connection pivot located on a side farther from the second arm-side pivot than the second body-side pivot.

4. The holding apparatus according to claim 1, wherein at least one of the first arm and the second arm is a pivot restricting arm including a pivot restricting part, which restricts a pivot of a restricted holding element relative to the pivot restricting arm within a limited range, the restricted holding element being a holding element selected from the first holding element and the second holding element and connected to the pivot restricting arm.

5. The holding apparatus according to claim 4, wherein the arm lower region of the pivot restricting arm has a pair of support members disposed on both sides of the restricted holding element in the front-rear direction to pivotably support the restricted holding element, the pivot restricting part being disposed between the pair of support members in the front-rear direction.

6. The holding apparatus according to claim 5, wherein the pivot restricting part is configured to abut against an upper surface of the restricted holding part along with the pivot of the restricted holding element to thereby restrict the pivot of the restricted holding part within the limited range.

7. The holding apparatus according to claim 6, wherein the pivot restricting part includes a restricting projection that projects from an inner surface of at least one of the pair of support members in the front-rear direction.

8. The holding apparatus according to claim 6, wherein the pivot restricting part includes an interconnection member that interconnects the pair of support members on an upper side of the restricted holding element.

9. The holding apparatus according to claim 1, wherein at least one of the first holding element and the second holding element is a low gravity-center holding element, which has a center of gravity located below a pivot axis of the low gravity-center holding element out of the first holding pivot axis and the second holding pivot axis.

10. The holding apparatus according to claim 1, wherein each of the inner contact surface and the outer contact surface of at least one of the first holding element and the second holding element is made of an elastic body.

11. The holding apparatus according to claim 1, wherein each of the inner contact surface and the outer contact surface of at least one of the first holding element and the second holding element has a slippage prevention structure.

12. The holding apparatus according to claim 1, wherein at least one of the first holding element and the second holding element is a composite holding element including: a holding-element body connected to the arm lower region of an arm corresponding to the composite holding element out of the first arm member and the second arm member; an inner contact member including the inner contact surface and fixed to the holding-element body; and an outer contact member including the outer contact surface and fixed to the holding-element body.

13. The holding apparatus according to claim 12, wherein the holding-element body is made of a material having higher rigidity than that of respective materials forming the inner contact member and the outer contact member, and the material forming each of the inner contact member and the outer contact member has elasticity higher than that of the material forming the holding-element body.

14. The holding apparatus according to claim 12, wherein the composite holding element further includes an inner fastening member that fastens the inner contact member with the holding-element body at a position retracted from the inner contact surface outward in the opening and closing direction.

15. The holding apparatus according to claim 12, wherein the composite holding part further includes an outer fastening member that fastens the outer contact member with the holding part body at a position retracted from the outer contact surface inward in the opening and closing direction.

16. A work machine comprising:
an attachment body having a distal end and being operable to move the distal end; and
the holding apparatus according to claim 1, wherein the holding apparatus is configured to hold the holding object while being connected to the distal end of the attachment body to constitute a work attachment in cooperation with the attachment body.

17. The work machine of claim 16, wherein the work attachment further includes a turning device interposed between the distal end of the holding-apparatus body and the attachment body of the holding apparatus and the turning device is configured to turn the holding-apparatus body relatively to the attachment body around a turning axis perpendicular to each of the opening and closing direction and the front-rear direction.

18. The work machine of claim 16, wherein the work attachment further includes a tilt device interposed between the holding-apparatus body of the holding apparatus and the distal end of the attachment body and the tilting device is configured to move the holding-apparatus body rotationally around a tilt axis relatively to the attachment body to thereby tilt the holding-apparatus body to the attachment body, the tilt axis being parallel to a plane including the opening and closing direction and the front-rear direction.
